(19) United States
(12) Patent Application Publication
(10) Pub. No.: US 2005/0144158 A1
(43) Pub. Date: Jun. 30, 2005

(54) Computer network search engine

(76) Inventors: Liesl Jane Capper, Chatswood (AU); Jondarr Colin George Henry 2 Gibb, Chatswood (AU)

Correspondence Address: ST. ONGE STEWARD JOHNSTON & REENS, LLC, 986 BEDFORD STREET, STAMFORD, CT, 06905-5619, US

(21) Appl. No.: 10/991,819

(22) Filed: Nov. 18, 2004

Related U.S. Application Data
(60) Provisional application No. 60/520,674, filed on Nov. 18, 2003.

(51) Int. Cl. G06F 17/30

(52) U.S. Cl. 707/3

(57) ABSTRACT

A computer network search engine is disclosed in which search results are analyzed to identify one or more themes, and individual results are clustered according to one or more of the themes. In one aspect the user may be presented with a graphical representation of one or more cluster of results. In another aspect the search results are presented in the cluster according to a ranked list, and wherein the ranked list may be modified according to attributes of a selected search result and/or dynamically altered according to observations of the user examining the results.

### PRIOR APPLICATION

Applicants claim priority benefits under 35 U.S.C. §119(e) of U.S. Provisional Patent Application Ser. No. 60/520,674 filed Nov. 18, 2003.

### FIELD OF THE INVENTION

The present invention relates to search engines for computer networks, such as the Internet and Worldwide Web and, in particular, discloses a search engine which adapts to dynamic changes in user's preferences in search results.

### BACKGROUND

Search engines for accessing information across computer networks such as the Internet or World Wide Web (WWW) have been known for some time. Such search engines are implemented by computer programs typically executing upon server computers representing nodes to the computer network and through which individual users connect to the network.

Traditional search engines operate by examining documents, such as Internet Web pages, for content that matches a search query. The query is typically one or more keywords. Results returned by the search engine to the user are generally listed in descending order of compliance with the search query. Many difficulties abound with such forms of searching and this has resulted in the plethora of search engines that are currently available to users of the Internet. For example, many search engines use different criteria to extract what they consider to be meaningful results, which are then returned to the user. Some search engines for example utilise key words arranged within a question or phrase in an attempt to provide a more meaningful result.

In spite of the best intentions of developers of Internet search engines, the designers of web pages and other like (searchable) documents have skillfully been able to exploit certain search features, or lack thereof, in order to promote pages, that may poorly satisfy the search criteria, to locations highly ordered in the list of return search results. As a consequence, users often spend inordinate amounts of time examining search results in an attempt to find the information that they desire.

A number of search engines attempt to personalize a search for a user. Such personalization operates with a view to gain greater insight as to the types of search results that a user may prefer. One such search engine is understood to be AOL. Existing attempts at search personalization focus on ‘profiling’ and operate according to fixed factors, such as, for example:
(i) where does the user live?
(ii) how old is the user?; and
(iii) what is the user's occupation?

While this approach has some merit, such relies upon the assumption that the user does not change, and that the user would be willing to divulge such information. Other measures have higher predictive validity. For instance, the approaches of keyword analysis, such as “what words have they been searching for?” and “what are other people who made the same search looking for?”, are more interesting, but they are fundamentally engaging in guesswork.

### SUMMARY OF THE INVENTION

It is an object of the present invention to provide an improved form of information interaction.

In a first aspect of the present invention, search results arising from the searching query, are grouped into clusters with each cluster being founded upon an underlying theme present in each of the associated results. At a primary level, the clustered search results are presented to the user in a graphical fashion thereby limiting the number of initial choices that may be made by the user to the various themes of highest relevance underlying each of the clusters. This has the effect of focusing the user's attention onto one or more of the themes returned from the particular search query. The user may then examine results within a particular theme.

In another aspect of the present invention, the user's examination of the search results is used to dynamically reorder the presentation of the search results as the user completes viewing of a particular result and returns to a group of results for selection of the next item for review. As a consequence, criteria gleaned from a user's examination of a particular result can be used to modify and dynamically adjust the ordering of the overall search results to provide for those most highly ordered results to be presented to the user for review.

With these arrangements, the user applies a controlled filtering to the various search results so that those search results that best fit the user's dynamically changing search criteria, are presented in a highly ranked location to the user for further review. As a consequence, such an arrangement accommodates a situation where, having entered various search criteria (eg. keywords), and then having examined one or more search results, the particular search result may change in the mind of the user. Such may not be necessarily reflected by change in the search criteria or through a re-running of the search with the revised criteria. The continually modifying criterion that arises from the user reviewing individual search results has the capacity therefore to modify the presentation of those further results that may be viewed by the user.

In accordance with a further aspect of the present invention, there is provided a method of improving a user's online information searching capabilities whilst utilizing a computer interface for information searching, the method including the steps of: (a) providing the user with an interface for information searching; (b) monitoring a user's utilization of the interface; (c) classifying the sophistication of the monitored behavior in accordance with a series of criteria; (d) utilizing the classification to alter the characteristics of information provision to the user of the interface.

Preferably, the interface clusters information of relevance to a search and the alteration can comprise altering the relevance of clusters in accordance with the classification. The interface can cluster information of relevance to a search and the classification can be correlated with the user's interaction with the clusters. The classification can be correlated with the perceived sophistication of interrogation of the interface. Further, the classification can be correlated with a perceived personality type of the user. The perceived personality type can be derived from the user's interaction with the interface. The derivation preferably can include a factor of whether the user's interaction included Boolean operators.

Other aspects of the present invention will become apparent from a reading of the detailed description.

### BRIEF DESCRIPTION OF THE DRAWINGS

At least one embodiment of the present invention will now be described with reference to the drawings in which:

FIG. 1 is a schematic block diagram representation of computer network within which the described arrangements may be performed;

FIG. 2 is a schematic block diagram representation of a computer system useful in the network of FIG. 1;

FIG. 3 is a flowchart of a computer network search method according to the present disclosure;

FIG. 4 is a representation of an exemplary GUI for a primary search result;

FIGS. 5A and 5B are representations of an exemplary GUI for clustered search results;

FIG. 6 schematically illustrates relationships between raw search results and clusters formed from the raw results;

FIG. 7 is a flowchart of a dynamic action amplifier component of the flowchart of FIG. 3;

FIG. 8 is a table representing an example of the operation of the dynamic action amplifier of FIG. 4;

FIG. 9 illustrates major components of a preferred search engine approach;

FIG. 10 illustrates a behavior model underlying the search engine;

FIG. 11 illustrates the process of derivation of user parameters;

FIG. 12 illustrates an example matrix of user parameters; and

FIG. 13 illustrates a class relationship between user parameter variables.

### DETAILED DESCRIPTION INCLUDING BEST MODE

1.0 Introduction

Some portions of the following description are explicitly or implicitly presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “calculating”, “determining”, “replacing”, “generating” “initializing”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also discloses a computer readable medium comprising a computer program for performing the operations of the described methods. The computer readable medium is taken herein to include any transmission medium for communicating the computer program between a source and a designation. The transmission medium may include storage devices such as magnetic or optical disks, memory chips, or other storage devices suitable for interfacing with a general purpose computer. The transmission medium may also include a hard-wired medium such as exemplified in the Internet system, or wireless medium such as exemplified in the GSM mobile telephone system. The computer program is not intended to be limited to any particular programming language and implementation thereof. It will be appreciated that a variety of programming languages and coding thereof may be used to implement the teachings of the disclosure contained herein.

The principles of the preferred method described herein have general applicability to computer network search engines. However, for ease of explanation, the steps of the preferred method are described with reference to Internet search engines. However, it is not intended that the present invention be limited to the described method. For example, the invention may have application to searching within private data sources.

The aforementioned preferred method(s) comprise a particular control flow. There are many other variants of the preferred method(s) which use different control flows without departing the spirit or scope of the invention. Further, one or more of the steps of the preferred method(s) may be performed in parallel rather sequential.

Overview

The preferred embodiment involves a method of organizing information, (information comprising: search results, published content on the internet, and internet advertising), based on various detected personal characteristics of the user. The method dynamically ranks the information, it changes the order in which information is presented based on the selection of content or other behavior the user exhibits. It attempts to determine which information is likely to be interesting to the user and therefore which should be presented first or exclusively. The outcome is search results and published content which are more relevant to the individual user, and advertising the user is more likely to respond to positively.

This ranking is based on
themes of interest, based on single content selection, longer-term tracking of content selection, and other behavior of the user.
behavior, and how that relates to the individuals personality and information processing style
the content itself: an individual piece of content or advert is scored on how appealing the information is to a particular type of individual, with a particular psychographic orientation. In this way we can select new search results, content or advertisments without profiling, simply by matching the new content as closely as possible to the dominant or original result or content.

The themes are extracted from the content by grouping documents related to the original document, and extracting themes from the whole group. This give an understanding of the individual content in the context of related documents.

Approach

The method of the preferred embodiment attempts to predict what sort of information a user will prefer based on:
a) Who the person is (personality, motivation, emotions)
b) What their situation is at that time.

The method reacts to the fact that people will act differently when interacting with information, for example when they are finding out about things, and when they are making consumer choices. These differences are significant, and can be detected by behavior. The differences are driven by differences in personality, cognitive style (or information processing style) and situation.

The preferred embodiment method determines behaviors in the context of finding information (INFOBEHAV) best reflect underlying individual differences (PERSON). The observation of behavior, content choice and underlying personal differences is then used to predict what sort of information or content a person would like to see (SATISFACTION), which sponsored content they would best respond to (CONVERSION), and the preferred format & depth of information provided (LOOK&FEEL). These latter three are collectively called the desired outcome (OUTCOME), to differentiate it as a broader concept than the current narrow perception of search results as a long list of text results.

2.0 Structural Arrangement

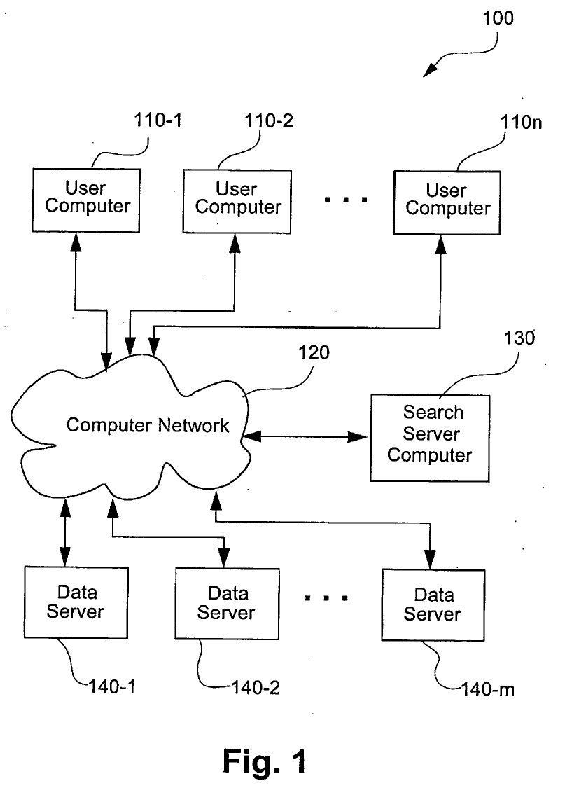

FIG. 1 shows an exemplary computer network 100 in which the arrangements to be described may be practised. One or more of user computer devices 110-1, 110-2, . . . , 110-n connect to a computer network 120 such as the Internet or World Wide Web, through a public switched telephone network or cable network for example, in order to access data sources retained by one or more computer data servers 140-1, 140-2, . . . , 140-m. A further server computer 130 is seen and provides a search engine function available to the user computers 110 and the data servers 140. In some applications, the search engine function may be incorporated, in part or whole, upon any of the computers 110 or 140.

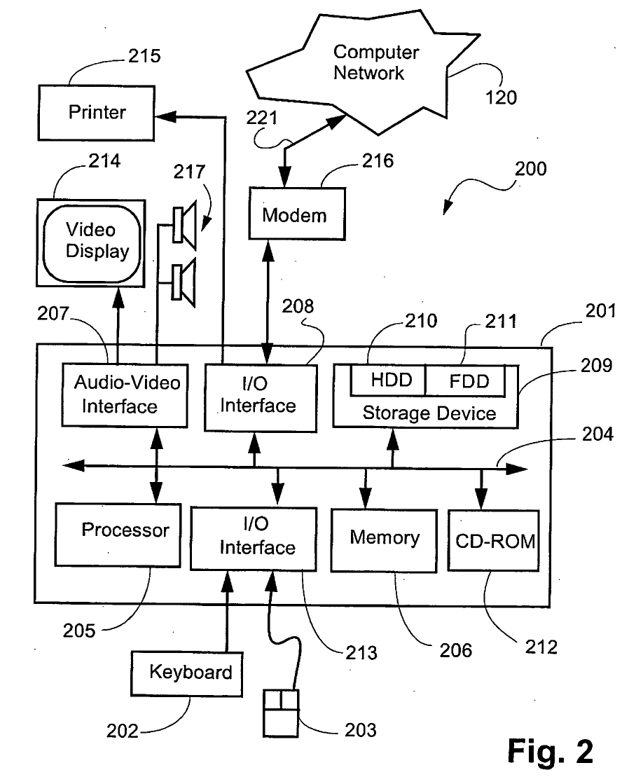

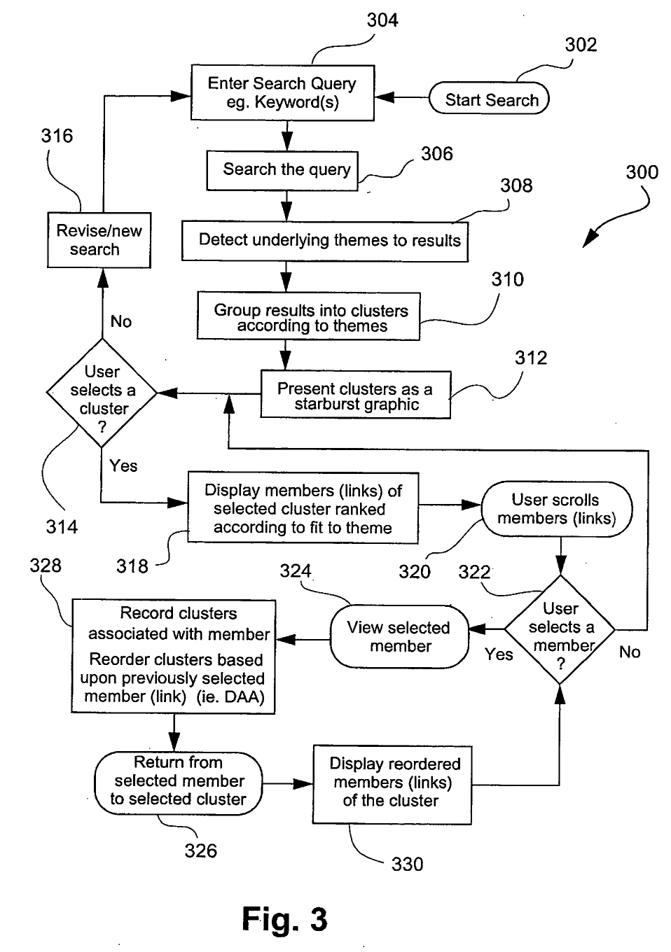

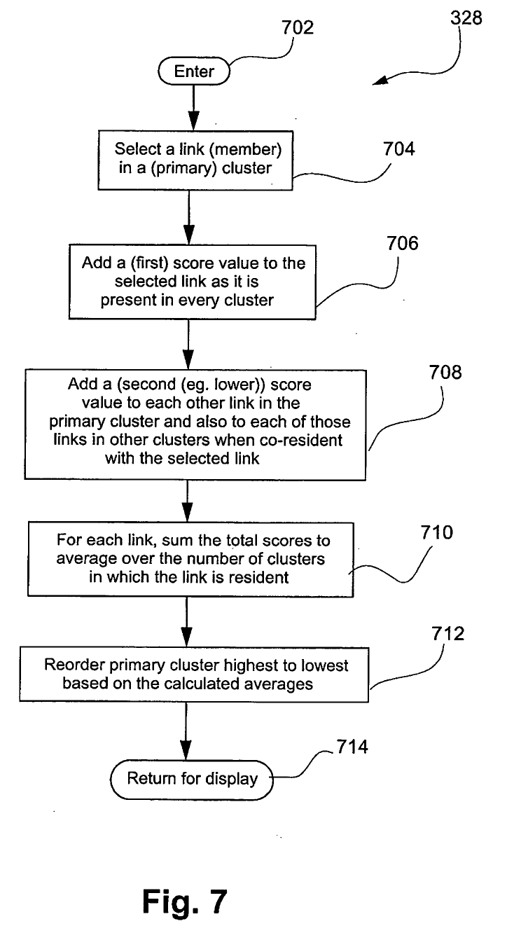

Each of the computers 110, 130 and 140 may be implemented by a general purpose computer and the described search engine methods may be performed upon such. An example of such a computer is seen in a general-purpose computer system 200 as shown in FIG. 2. The search engine processes to be described with reference to FIGS. 3 to 8 may be implemented as software, such as an application program executing within the computer system 200. In particular, the steps of method of FIGS. 3 and 7 are effected by instructions in the software that are carried out by the computer. The instructions may be formed as one or more code modules, each for performing one or more particular tasks. The software may also be divided into two separate parts, in which a first part performs the search engine methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for computer network searching.

The computer system 200 comprises a computer module 201, input devices such as a keyboard 202 and mouse 203, output devices including a printer 215 and a display device 214. A Modulator-Demodulator (Modem) transceiver device 216 is used by the computer module 201 for communicating to and from the communications network 120, for example connectable via a telephone line 221 or other functional medium. The modem 216 can be used to obtain access to the Internet, and other network systems, such as a Local Area Network (LAN) or a Wide Area Network (WAN).

The computer module 201 typically includes at least one processor unit 205, a memory unit 206, for example formed from semiconductor random access memory (RAM) and read only memory (ROM), input/output (I/O) interfaces including a video interface 207, and an I/O interface 213 for the keyboard 202 and mouse 203 and optionally a joystick (not illustrated), and an interface 208 for the modem 216. A storage device 209 is provided and typically includes a hard disk drive 210 and a floppy disk drive 211. A magnetic tape drive (not illustrated) may also be used. A CD-ROM drive 212 is typically provided as a non-volatile source of data. The components 205 to 213 of the computer module 201, typically communicate via an interconnected bus 204 and in a manner which results in a conventional mode of operation of the computer system 200 known to those in the relevant art. Examples of computers on which the described arrangements can be practised include IBM-PC's and compatibles, Sun Sparcstations or alike computer systems evolved therefrom.

Typically, the application program is resident on the hard disk drive 210 and read and controlled in its execution by the processor 205. Intermediate storage of the program and any data fetched from the network 120 may be accomplished using the semiconductor memory 206, possibly in concert with the hard disk drive 210. In some instances, the application program may be supplied to the user encoded on a CD-ROM or floppy disk and read via the corresponding drive 212 or 211, or alternatively may be read by the user from the network 120 via the modem device 216. Still further, the software can also be loaded into the computer system 200 from other computer readable media. The term “computer readable medium” as used herein refers to any storage or transmission medium that participates in providing instructions and/or data to the computer system 200 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 201. Examples of transmission media include radio or infra-red transmission channels as well as a network connection to another computer or networked device, and the Internet or Intranets including email transmissions and information recorded on websites and the like.

3.0 Search Method

Development of the search engine according to the present disclosure approached the problem from the human perspective, with a number of assumptions, such as:
(i) what is relevant for one individual is (usually) not relevant for another;
(ii) the individual is likely to not want to provide data on themselves, so the search engine must assume that it will have minimal information to work with; and
(iii) the individual changes over time.

An important aspect of web searching is relevance, and the present inventors set themselves the task of creating a results presentation which is relevant for a particular person at a particular point in time.

FIG. 3 shows a flowchart of a search engine method 300 that is typically implemented as a computer program by the search engine server 130 of FIG. 1. The program interacts with information, such a search queries, received from a calling one of the user computers 110 and returns information to the user computer 110 for the presentation of search results to the user. The user computer 110 typically executes a web browser application, such as Internet Explorer™ (Microsoft Corp.) or Netscape Navigator™ (Netscape Corp.) within an operating system such as Windows™ (Microsoft Corp.) to provide access to the Internet or WWW. The browser application has the ability to display documents or other files sourced from the Web in response to user input. Generally, the search engine is accessed from a so-called “home page” where access to a number of different search engines may be available. The interaction can be provided by a Web CGI application. Initially, the user will enter a search query, such as one or more keywords and select a desired search engine for conducting the search. In the present instance, the search engine of the method 300 is selected and the web browser application transmits the query to the server 130.

On receipt of the message from the user computer 110, the search server 130 starts the search program at step 302 as a particular instance for the calling user computer 110. From the calling message, the search query is extracted and entered into the search engine application at step 304. In step 306, the search engine conducts a search on the query. The search conducted at step 306 may be a traditional keyword-style search or one based upon a search phrase or a customised search. Examples of search functions that may be used in step 306 are those afforded by search engines currently available on the Web, such as Google™, Yahoo™, AltaVista™, WebWombat™, and Looksmart™, to name but a few. The search conducted in step 306 generates effectively a traditional search result comprising a list of results, in the form of Web pages defined by Uniform Resource Locators (URLs). This search result is, unlike the traditional search engines not returned to the user computer 110 but recorded and further processed by the search server as part of the search engine application 300.

At step 308, the application 300 examines the raw search result with a number of algorithms to identify underlying themes to the results. For example, it s not uncommon for a typical result to return 100-200 individual Web pages of various relevance to the search query, some of which may only have a small relationship to the query or a part thereof. Step 308 operates to examine the content of each result (as compared to a metadata terms placed in locations of prominence to “attract” dominance from traditional search engines) to identify one or more themes that may be present in the content of the result. The themes need not be founded upon the search query as the query has been, more or less, satisfied by the raw search result determined in step 306, and may be gleaned from content of the page such as headings or names attached to images. Examples of the algorithms that may be used in such examination of the search result are discussed later in this specification.

Step 310 follows and operates to group the Web pages of the raw results into clusters each associated with the identified themes. In this regard, any one result may have identified with it more than one theme and, as a consequence, a single search result may be associated with more than one cluster. The grouping performed by step 310 operates upon the identified themes and the extent to which any one web page result matches the identified theme.

For example, if a user inputs the word “travel”, the step 306 retrieves results for “travel” but before processing these results, the step 308 reviews them by pushing them through a nodal structure upon which various clusters of results aggregate. In the present example, a particular result may have “travel”, “Bali”, “terrorist”, “travel warning”, as clusters, whereas another result may have “travel”, “Bali”, “hotels”, “sightseeing”, “daytrips”, as clusters. The clusters are ranked, and a selected number of cluster groups (eg. the top twenty) are presented to the user in step 312.

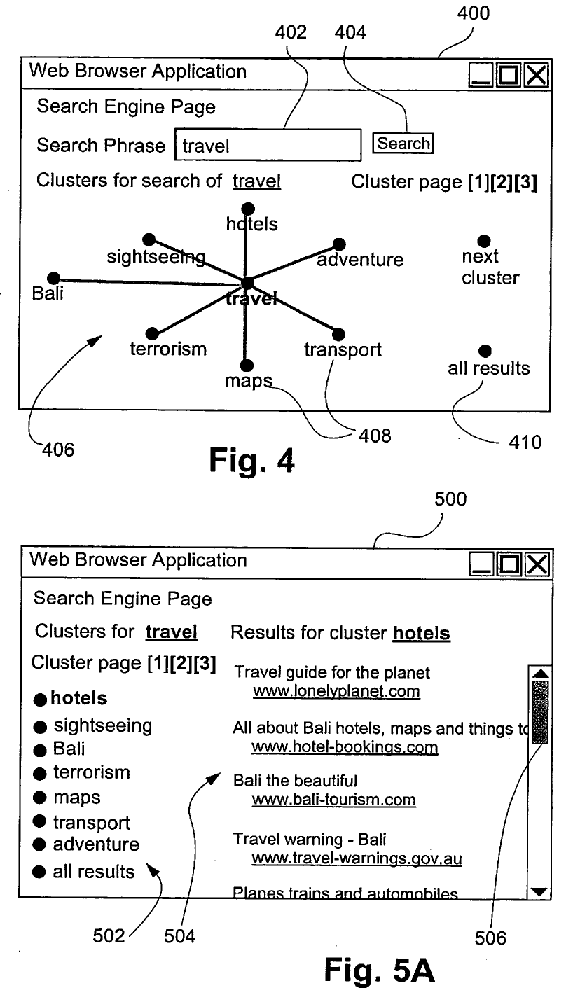

The presentation in step 312 occurs by the search server 130 returning to the user computer 110 a web page incorporating a graphical representation of the most prominent clusters. This web page is interpreted by the browser application operating upon the user computer 110 and presented with the graphical use interface (GUI) of the browser application. An example of such a presentation is seen in FIG. 4 where the GUI 400 depicts the cluster search result for the query “travel”. In this example, there are three pages of clusters able to be presented and page one is shown. The clusters are presented in a “starburst” fashion 406, centred upon the search query and linking to those clusters named after corresponding themes underlying individual results associated with each cluster. Each of the clusters is presented as a graphical icon 408 able to be selected by the user through operation (eg. clicking) of the mouse pointer 203 associated with the user computer 110. The GUI 400 also has an icon “all results” 410 which can present the entire set of results in an un-clustered form. “All results” 410 corresponds to the traditional search result obtained from step 306 and may be considered as a cluster with an underlying theme of nil or null.

The starburst presentation 406 of the clustered results is used as such firstly limits the amount of information being presented to the user at a single instance (eg. seven clusters only), whilst providing the user with a higher level of insight to the themes of results available in each cluster. From a psychology point of view, the human mind prefers to deal with no more than 3-5 chunks of data at once. On this basis, categories are shown at less than eight per page, with the option to view more as required. The categories are shown as areas surrounding the search keywords, increasingly farther out with lower-ranked categories.

After forwarding the clustered result to the user for display in step 312, the method 300 awaits a response from the user computer 110. If the user is not satisfied with the presented results, a further or revised search may be detected at step 316. This, for example, may be in response to the user entering a revised query into the search phrase dialog 402 and selecting the search icon 404, as seen in FIG. 4. When such a revised search is detected, the method 300 returns to step 304 where the new query is processed in the fashion described above.

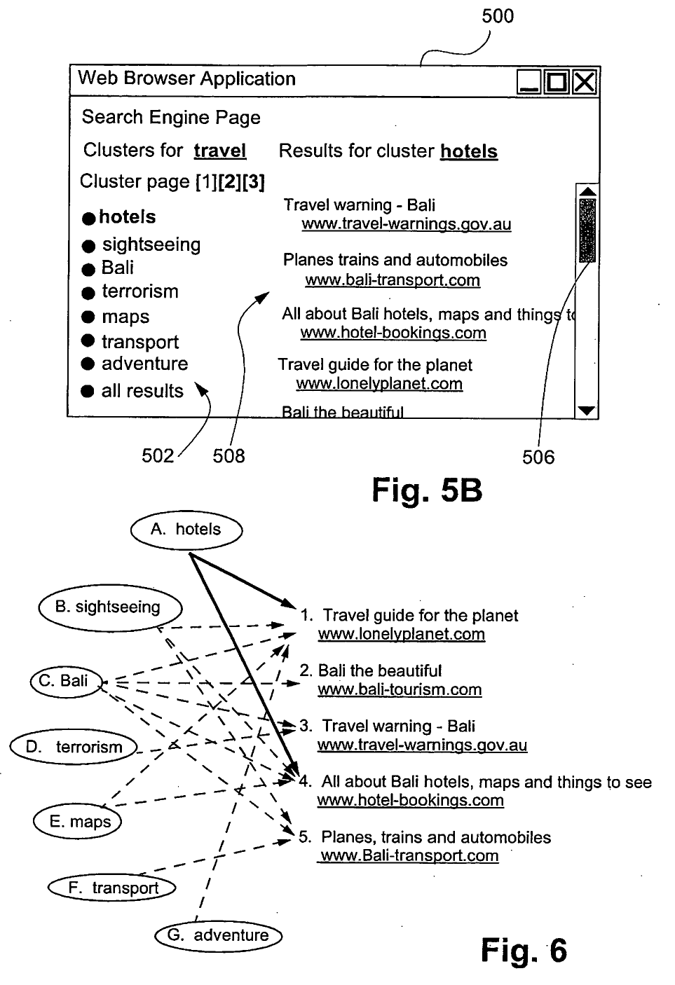

When the user selects a cluster, by a click of the mouse 203 for example upon a cluster icon 408, as detected in step 314, step 318 operates to present the search results associated with that selected cluster to the user. Each cluster displays a number of results relevant to that particular cluster. An example of this is seen in FIG. 5A where, form the example of FIG. 4, the user has selected the “hotels” cluster and a search result page is returned for display in the GUI 500. As seen, the various clusters are listed 502 on the left hand side of the GUI 500 and the individual results for the “hotels” cluster are listed on the right hand side at 504. As will be apparent from FIG. 5A, the listed results are ranked according to relevance to the underlying theme of the selected cluster and can include results that may not be typically thought to be associated with the cluster. In this instance, whilst the displayed results at 504 show relevance to hotel bookings, an entry relating to travel warnings may be included as such can related to hotel security.

The user may review the results, being members of a set of links defined by the selected cluster by manipulating a scroll bar 506 using the mouse 203. Where a particular result/member attracts the attention of the user, such may be selected by the user through a mouse click and the browser application will then access the URL associated with the result via the search server 130 for consequential display within the GUI of the browser application. The user may then view that URL at leisure.

Whilst the URL of the selected member is being viewed, step 328 updates a record of all clusters associated with the selected member. Using the updated record step 328 further operates to reorder the members of the selected cluster based upon a newly perceived priority placed by the user upon the selected member. This has the effect of reordering the members of the cluster based upon the attributes of the selected member compared to the other members of set defining the cluster.

Upon the user instigating a return at step 326 from the review of the selected member result, the reordered members of the cluster are then displayed to the user at step 330. By this, instead of the browser application returning to the earlier (exact) page display, seen in FIG. 5A, from which the particular member was selected for viewing, steps 328 and 330 operate to alter the display page to that shown in FIG. 5B.

Using the example of FIG. 5A, although the cluster is “hotels”, if the user selected “Travel warning—Bali”, even though “Travel guide for the planet” was more highly ranked within the cluster, upon returning from reviewing the travel warning, the members of the hotel cluster will be re-ranked according to the perceived interest in security issues. As seen in FIG. 5B, the “Travel warning—Bali” has been elevated in the modified cluster results 508 to most highly ranked, followed by a site related to transport, which has greater relevance to security issues than the remainder, which relate to hotels and tourism in general.

With this approach, two different users who input the search word “travel” and select a cluster entitled “Bali” as a consequence may have completely different results returned. One may be interested in staying safe and comfortable, whereas the other user may want adventure and beauty. Since search engine 300 understands the themes underlying the search, when a user selects a particular site, the search engine 300 is able to find other sites with very similar clusters. By the time the user has selected two sites, the search engine 300 is thus able to determine that the first user is far more interested in terrorist threats than in beautiful daytrips and the results are ranked accordingly. In this fashion, ranking of results actually occurs whilst the user is conducting a search.

The search engine 300 is able to do this because of an understanding of the clusters within the results. This results in a form of personalization which is based upon current interests, and not upon a set “profile” or assumptions made upon the basis of demographics, as is common in traditional Internet search engines.

The ranking of results is based on clusters inside the website selected, and the order of dominance of those clusters. Upon selection of the first search result, the search engine 300 is able to detect other results with common clusters, or other search results with the most common set of cluster associations, and make an appropriate association between them. Once the second result is selected, the search result can rank according to the highest overall intersection of sets. As such, the first user in the example above who is interested in staying safe can search upon the word “travel” and selects the cluster “Bali” and the first site he chooses has a cluster set of Bali, accommodation, and terrorism. The second user in contrast who also inputs “travel” selects the cluster “Bali” but all of his choices relate to adventure sports, para sailing, diving and he chooses nothing with “terrorism” in it. By analysing their choices, and the theme pattern under their choices, the search engine 300 is able to make reasonable assumptions as to their particular interests.

Once step 330 has presented the reordered cluster results to the user, the search engine method returns to step 322 to detect selection of another one of the members of the reordered cluster results. If no such member is selected, the user may select another cluster, by the method 300 returning to step 314.

FIG. 6 shows the relationships between the clusters and the individual search results used in the examples of FIGS. 4-5B. As seen in FIG. 6, various relationships between the actual search result and the various identified clusters is indicated, together with a relationship between results and multiple clusters.

The described search engine method 300 makes use of two significant aspects. A first is being the clustering of search results (step 310), and the second is the dynamic amplification of user actions (step 328). These operate individually and collectively to afford a focussed presentation of search results that is intended to follow the user's perceived desires, and not what a specific search algorithm may dictate, as in many prior art arrangements. These aspects may now be discussed in greater detail.

4.0 Clustering

With the clustering approach, the displayed results are presented around the idea that documents, and therefore web documents as results to a keyword search, can be grouped by their content. This affords the user a better understanding of the underlying relationships between the documents, and also enables the user to more easily understand content and decide on its the relevance to a given problem. It is not possible to para-psychologically interrogate the user for their intentions, and the user must make the final decision on relevance. The purpose of the search engine 300 is to present the best options from which the user may choose.

Clustering is the similar to using a table of contents from the front of the book, rather than using an index in the back. Thinking structurally, the chapter headings of the book give a better indication of the content of the pages than does the index. The index gives a list of pages containing a word or phrase. The table of contents gives a section of the book encompassing a concept in the mind of the user.

Clustering is a way of trying to rebuild the table of contents from the index. The algorithm used as a basis on which to develop the present implementation of clustering is one suggested for web-based documents in “Web Document Clustering: A Feasibility Demonstration”, Oren Zamir & Oren Etzioni, University of Wisconsin.

Clustering only goes part way to producing good results. Once the documents have been arrayed into a of myriad of phrases that make candidate clusters or categories that a user might understand, a merging of the candidates that represent the same ideas is required to give meaning to the clusters. From a book point of view, if a certain phrase appeared on ten different pages of the book, and another phrase appeared on nine of those pages, plus one more, it would be reasonable to assume that there was a relationship between those two phrases. In the parlance of the search engine 300, the clusters are similar, and the resultant cluster will contain a merging of those page lists.

From a human point of view, phrases that carry the same or a similar meaning should be in the same category. An example of this might be “he ate some cake” and “Tom ate some cakes”. In a certain context, these could well have the same meaning to someone. Algorithmically, to determine this would be difficult. However, given that “cakes” is merely the plural of “cake”, and Tom is most likely a “he”, it could be reasonable to put these two phrases into a category of “he ate some cakes” (which is a simple amalgam). The user would then be able to perform the necessary extrapolation between each of the two phrases themselves.

This minimum understanding of English is required only that the user understand how to find the stem of a word, and that users have a way of determining the similarity of phrases where one or two words are mere linguistic placemarkers. A stemming algorithm, such as that described in “An Algorithm for Suffix Stripping”, M. F. Porter (1980) Program, Vol. 14, No. 3, pp. 130-137, “the Porter reference”, allows handling of plural and many other suffixes. Other algorithms may be used for determining phrase similarly in terms of word occurrence, and sub-phrasing, for instance. Speed becomes an issue with more complex solutions.

The technological heart of the solution goes a long way to differentiating our application from other search engines. The building of a cluster tree, as described in the Porter reference, and the process of merging clusters, can be a time-consuming, computationally expensive activity. Optimisation may be required in some instances to ensure that the extent of processing of raw search results does not impact negatively on the results as they are presented to the user.

Using the clustering approach described herein, a paid listing module may be created that dynamically generates content based on both the original query (as most search engines do) and the cluster selected by the use. Such may also extend to the provision of dynamic links to a directory of web sites. The net result of this is a method by which additional content, including, but not restricted to, paid listings, directory entries, and direct content of web pages, is incorporated into a display of clustered search results, based on themes common to the user's selections.”

5.0 Dynamic Action Amplification

Step 328 operates, as termed by the present inventors, as a Dynamic Action Amplifier (DAA), to react to user input to assist in bringing search results that are most pertinent to the fore. The resultant list of document links for each cluster needs to be dynamically re-arranged based on the choices made by the user, such that more closely associated links are considered relevant and bunched towards the top of the page for the user's convenience.

Although described above in the method 300 as operating within the search engine server 130, the DM of step 328 may alternatively be operated in the user's computer by way of an agent program downloaded from the search server 130 via the web browser application. As such the DAA may operate as a client-side piece of functionality. Any dynamic re-ordering algorithm implemented on the user computer 110 needs sufficient data supplied by the server 130, and so the implementation of the DAA must have a matching implementation and data origin on the server side 130. This may be achieved by merely filtering of existing data to provide extra data structures.

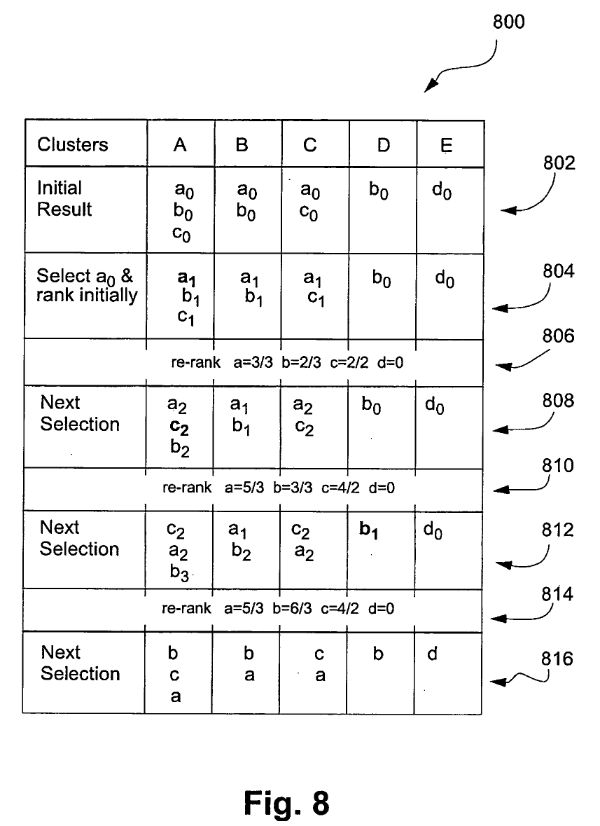

FIG. 7 shows a flowchart for the DAA of step 328 which may be performed on either the user computer 110 or the search server 130 depending on the particular implementation. The method of FIG. 7 includes associating a relevance score with each cluster, and scoring each selection of a link by the user as increasing the relevance for each of the categories associated with that link, regardless of how many are displayed, with the link, to the user. Each link, across all categories then has a total relevance calculated for it, based on the average of all of the categories it appears in. The links are then ranked by this relevance, highest first, and displayed in this order when the user returns to the search page (hitting the ‘back’ button after following the link). This can now be explained in more detail with reference the method steps of FIG. 7 and the example of FIG. 8.

Step 702 represents an entry point of a sub-program within the search server method 300 or the agent installed upon the user computer 110. FIG. 8 shows a table 800 of all clusters (A, B, . . . , E) formed from a raw search result having members/links (a, b, c, d). FIG. 8 shows an initial ranking 802 of the results within the respective clusters ordered from highest to lowest in a traditional ranking fashion. Associated with each member/link in each cluster is a score value, seen as a subscript, which initially is set to zero.

In step 704, the method detects the user selecting a link for viewing (equivalent to step 324 of FIG. 3), in this case being link a in a primary cluster A. Step 706 then operates to add a score value to the selected link as that link appears in each cluster. Accordingly, link a has the value one (1) add in each of clusters A, B and C. Step 708 then operates to add a score value to each other link in the primary cluster A and also to those same links where those links appear in a cluster in which the selected link a appears. This results in the ranking and scoring shown at 804.

Step 710 operates, for each link, to sum the total scores of associated clusters and determine an average by dividing this sum by the total number of clusters in which a link is resident. This calculation is depicted at 806 as a re-ranking calculation. Step 712 follows to re-rank the links, form highest to lowset, in the clusters according to the calculated averages. The result of this first re-ranking is seen at 808. These results are returned for display at step 330 when the user returns from the viewing the selected link.

The same process then repeats for each further selection of a link from any of the clusters. From 808, the user selects link c in cluster A. As a consequence the “score” for that link increase from 1 (in 804) to 2 (in 808) according to step 706. Other scores are then updated according to step 708 to give the various subscripts seen at 808. Step 710 then performs the re-ranking calculation which has the result of elevating link c to prominence in cluster A and also cluster C this being seen at 812.

When the user returns from viewing link c, the rankings appear as at 812, although only those for cluster A are presented directly to the user (see FIG. 5B). In the next iteration, the user changes clusters (for whatever reason the user may desire—as user's do) and selects link b from cluster D. The method is again repeated with a consequential re-ranking occurring as shown at 814 and 816 respectively. Note that 816 does not show any subscripts as such only relate to any selection made from the ranking of 816. Significantly, the selection of link b from cluster D has resulted in a re-ordering of the rankings in clusters A and B.

In a preferred implementation, the “score” value ascribed to a link may be positively weighted to enhance the scores of those links that are actually selected, as compared to those that may be similarly classified and whose score may merely follow those of the selected links. For example, the (first) score value from step 706 may be two (2) whereas the (second) score value from step 708 may be one (1). Whilst the example of FIG. 8 is very simple for only a limited number of clusters and links, the method readily extends to much larger data sets as typically encountered with Internet searches.

In summary, the DAA operates such that:
(i) the relevance of the selected search result is increased;
(ii) the relevance of each cluster that the search result is a member of is increased;
(iii) the relevance of each search result is calculated as a function of the relevance of each of the clusters in which it is a member; and
(iv) the results are then displayed in order of relevance.

This allows for weightings to be applied, and variations on the algorithm along the lines of “the cluster being viewed will get a higher rating”—which is a useful feature if skipping between clusters is employed by the user (where the DAA is enabled across cluster views). The re-ordering is based on an analysis of the user's selections, and a prediction of what search results are similar based on the user's choices at that time. Dynamically amplifying the user's actions is performed.

Significantly, the personalization afforded by the DAA is actually independent of clustering, and may be applied to other forms of search result presentation. For example, by ignoring clustering, the DAA may be applied directly to the entire search result, this being equivalent for example to the null cluster “all results”, discussed above.

The scoring may be moved to the sever side under the some implementations, which means that the user side merely reads the score from provided data structure and ordered the list of results. Otherwise, the same principles apply. Moving the DAA to the server side also brings with it some session-based requirements to ensure that individual user's results were only affected by their actions. This also means that session timeouts can occur, and user's might be required to perform the search again if they left their browser unattended for, say, ten minutes. When data minimisation is desired, then the scoring based on information in the DAA may also moved to the server side.

Implementation of the DAA can raise some issues that may be handled in a variety of ways. For example, when should the score be reset? This may be done upon choosing a new cluster (as compared to the above example), or only on a new search defined by a new or revised query.

Further, although the search engine 300 is intended to deliver the desired search result to the user in a single search operation, in a real-world scenario, a user will likely make a series of searches narrowing down their search. This is the experience from users of prior art search engines where such is necessary. As such is there a need for multi-search scoring? In theory, one search should be enough should be sufficient, however where desired the scoring results may be retained for one search and combined with those of a subsequent search to further highlight documents of greater perceived relevance. Alternative, scoring may be session-based. Here, the server-side implementation may retain scores over a user session.

Further, when applying the DAA, clustered results are but one possible input to the user experience. Another option is to use categorised results, as seen in the DMOZ™ and Yahoo™ search engines, where search results have predetermined categories (not dynamic, as in the above described case). In these circumstances, the categories supplied can be the basis on which relevance or otherwise unrelated search results can be obtained. In this case, there is a direct correlation of set membership—results as members of clusters or categories equate—but the means by which the sets themselves were obtained is different. The above discussion in terms of ‘themes’, which are currently implemented as clusters are achieved through phrase-analysis of search result content. These ‘themes’, however, are place-markers for any methodology applied to the grouping of search results, whether static or dynamic. Simpler themes that may be used include the number of occurrences of the search query within each result, or the occurrences of groups of words within the query, such that, for a query of “Bali bomb terror”. Results may be grouped as those containing each word, those containing pairs, and the triple, forming seven overlapping groups. The group that contained the most relevant results would be higher scored as the user followed more links in that group. This example shows how broad a manner of grouping might be applied, and in which the DAA has worth.

6.0 Behavior Pattern Monitoring and Modification

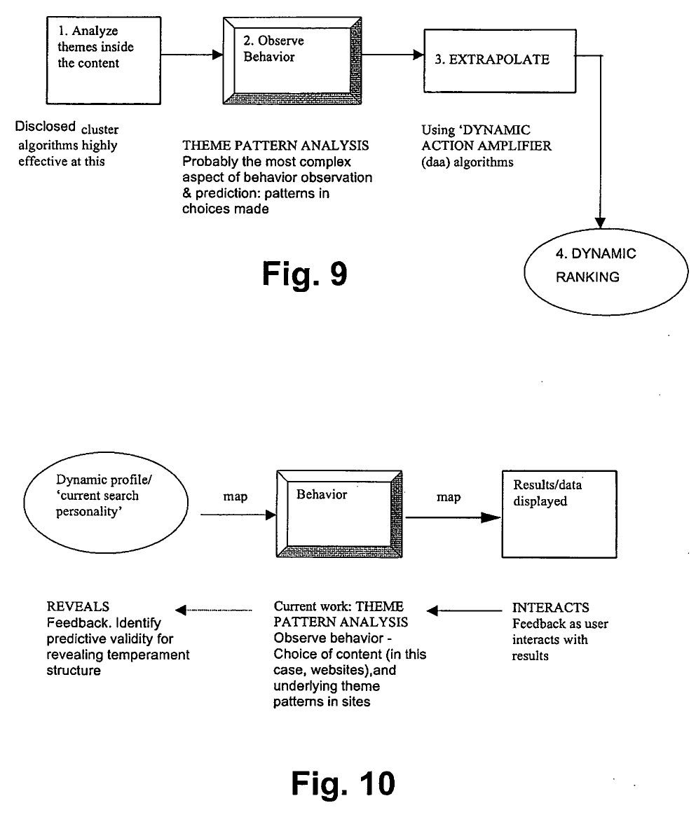

FIG. 9 illustrates conceptually the general processes of the above-described search engine. This initially involves, as shown, analysing themes within content, with this being effected by clustering approaches to handling results. From the themes, behavior may be observed, from which patterns in choices may be determined. Those patterns are then extrapolated using the dynamic action amplifier to positively bias results based on the behavior patterns to afford a dynamic ranking to the user.

A further aspect of the present disclosure observes behavior of web searching and represents an extension beyond the simple observation of websites selected. The behavior observed can used to influence the order of presentation of search results to include features such as:
(i) like the complexity of the search request (use of brackets and building operators),
(ii) the length of the request,
(iii) the speed of which the user enters the request,
(iv) the speed of selection of sites,
(v) the content of the website the searcher looks at longer,
(vi) the points of which scrolling slows down,
(vii) the length of time between stopping scrolling and when a click is made, and
(viii) how long the user spends at particular sites.

These criteria and features may be further interpreted, in the fashion shown in FIG. 10. The basis of prediction can now be discussed. Certain behavior patterns correlate with broad trends in subject matter sought. As an example, assume a search phrase “java”. If a user inputs complex search queries with Boolean operators, such a user is more likely to be technically literate and more likely to be interested in “java” as a programming language. If, on the other hand, the user inputs the search phrase rapidly, but has brief intense search sessions and hops quickly from one web site to another, then that user may be more likely in looking for “java coffee”. A user who puts in a broader word like “travel”, and slowly clicks on the first two sites presented, maybe more likely to be a school child or an older web user looking for information on the island “Java”.

Such a model is based upon observing session-specific behavior and behavior over multiple sessions, and on content the user spends more time working upon in order to make assumptions on profile and assumptions of desired contents sought by the user.

In addition, the model investigates a correlation between search behavior and personality profiling or temperament measures and uses that correlation as a basis for prediction of preferred order of search results.

This approach involves developing a type of personality matrix. Such is not personality typecasting, but rather focuses upon an individual's dynamic movement along continuum of a apparent behavior patterns. Using this approach, there is no assumption that there is a position that the user's position on these continuums is static. The present approach is interested in particular continua which have been shown by psychological research to have a reasonable degree of predictive ability to conceptualise a two-way flow of information and responses in the searching methods. In FIG. 10, a dynamic profile of a user is developed based upon a current search personality. The dynamic profile may then be mapped to a behavior which in turn may be further mapped to the search results and data displayed to the user. Each of these aspects has a complementary reverse effect. The displayed results afford feedback to the search engine as the user interacts with the results. Further, the behavior complements the theme pattern analysis discussed above. This, in turn, reveals dynamic information regarding the temperament of the user thus aiding in a predictive ability of the search engine to better accommodate the user at that particular point in time.

The result of this is approach gives:
(i) development of an activity matrix including current action, content observed and content created;
(ii) an overlap between the DAA and the activity matrix finding areas of congruence, and measuring which apparent areas of congruence have highest predictive ability and using such to build an agent that is able to investigate and make decisions on behalf of the user.

The shift and approach here is the dynamic nature of the assumptions upon which the machine is working. This is based on the concept that an individual is fluid and evolving, as is the information (for which they are looking) and not a fixed type of person moulded in a certain way by genes and experience or social demographics as classical psychological theory propounds.

An important component of determining the reality of the resultant clusters in the method 300 is to look at the words that make up the phrase in the cluster. There are common words that give little meaning to a category, and are therefore not good differentiators. There are also good words that break down the categories of human knowledge into broad areas of understanding that the average user can easily recognise. These are both manually created lists, the latter coming from the highest level of a directory-based search engine. This list is not likely to change, but is easily updated. The list of common dictionary words is added to in honing the clustering algorithm.

Common words are preferably ignored when assessing the category's usefulness. Similarly, the good words are encouraged. The algorithm balances the category's name against the search engines' ranking of the documents associated with the cluster. Thus, a cluster that links to many of the highest-ranked pages provided by search engines (ie. step 306), regardless of the category name, would compete with the category name that encapsulates what we considered to be an easy concept for a user to grasp. These clusters would both be ranked highly.

Often, a search engine (ie. step 306), in particular one that is directory based, will provide categories as a part of their search results. These could be useful if the engines were more consistent in both offering and providing such a service. Although the intention of the solution developed is to effectively provide this information from the method 300, data supplied by human created directories may be used to weight the ‘goodness’ of the clusters developed in the method 300.

The combination of ensuring a breadth of search results, applying a document clustering algorithm, intelligent merging of categories, ranking resultant categories on the basis of both knowledge-oriented name analysis, and search-engine result ranking, and displaying the results in such a way as to maximise the user's ability to take in all of the options presented, give the described arrangements an edge in producing search results that are more relevant, and closer to a human reality than one based on technology.

We group INFOBEHAV into broader typologies (INFOTYPES), which are relatively consistent patterns for a person in a given situation, and which are valid predictors of OUTCOME.

We also refer to ‘online’ rather than ‘search’ or ‘internet’ as this technology is applicable in future search environments which are not constrained by text-based search, ie escaping the desktop computer, mobile or visual internet, multi media, multisensory environment the user will be immersed in, interactivity of the above, and personalization, not merely text-based data mining.

Theoretical Dimensions of Differentiation

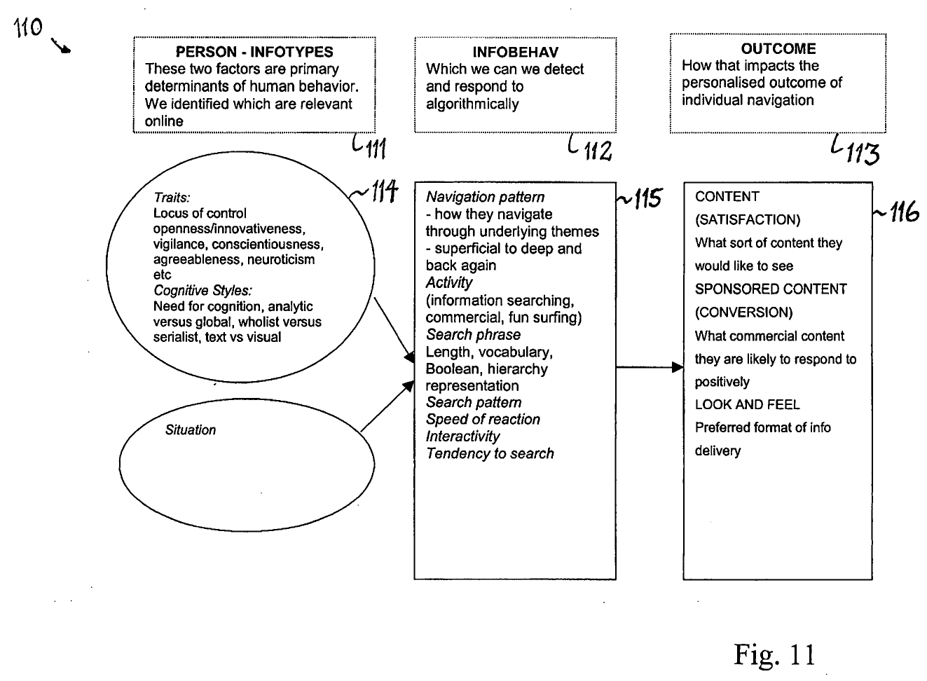

FIG. 11 expands on the relationship of FIG. 10. The preferred embodiment attempts to determine the psychometric information archetype (PERSON) 111 of the web user, based on their navigational style (INFOBEHAV) 112 and the content classification, and localised assessment applied to static information, changing content and contextual advertising content.

The preferred embodiment measures a series of behavioral traits. The is utlised to produce a series ouf outcomes 113 (content, advertisments, look-and-feel the user is positive about). Then the preferred embodiment determines which of those variables have strong correlations.

On this basis, the traits are grouped into personality typologies (INFOTYPES 111) which are a collection of traits and psychographic variables that occur together often in a given situation. In this case, we have selected traits and cognitive styles that occur together in online information navigation. The preferred embodiment then correlates the typologies to strong tendencies and behavior patterns online. The preferred embodiment is then able to observe behavior 112 and make assumptions about the underlying infotype, based on the observed behavior. We also score content based on the sort of user likely to respond positively to that content. We score behavior, and match that scoring to the score for the OUTCOME (CONTENT) 113 to deliver the content most interesting to that user.

Where it is necessary to apply the technology in a situation where the behavior track is not already available, ie we need to make predictions from a cold start; the search phrase itself (in the search engine example) can be used, or the single piece of content or information the user starts off with (in an online publisher example), and match the psychographic score of the starting point information, to the closest score of unseen content, to ensure the most appropriate delivery of content, advertising or Look & feel.

Personality traits 114 may be seen as individual pre-dispositions to behave in certain ways and are initially established through factor analysis of lexical descriptors The broadest domains are those of introversion-extraversion, emotional stability-neuroticism, agreeableness, conscientiousness, intellectual openness. A number of these traits are correlated with online behavior.

Openness

For example, openness to change is a personality trait that relates to being open to new circumstances as opposed to wanting to stay in familiar situations. High scorers are open to change and enjoy experimenting with new ideas and situations. Low scorers like routine and are attached to familiar situations. One could expect domain specific people to show more novelty seeking behavior, more risk taking and more sensation seeking behavior. This leads to such a person to explore a wider variety of product categories online, visiting a website to find information, and actually purchase more online.

Vigilance

Vigilance is a personality trait that relates to the tendency to trust versus being suspicious about others' motives and intentions. High scorers expect to be taken advantage of and may be unable to relax their vigilance when it might be advantageous to do so. Low scorers tend to expect fair treatment. Highly vigilant individuals are likely to be cautious about transacting on the internet.

Social Loners

Are people who experience social and emotional deficits in their lives due to lack of desire or failure to engage in successful social interactions. The social loner may be drawn to social networking on the internet, which gives them the opportunity to control and minimize real human interaction.

Conscientiousness

Diligent application to a task—conscientious individuals not only search more persistently (go past page 2, repeat a search until the find an answer) they also manifest distinct preferences as consumers, and in career choice.

Cognitive Styles/Information Processing Styles 114

A cognitive style is an individual preferred and habitual approach to acquiring and processing information. Cognitive style measures do not indicate the content of the information but simply how the brain perceives and processes the information. Cognitive styles are usually bipolar (ie manifest as one or the other, rather than the continua of traits) they are also relatively consistent across situation. For these reasons, plus their importance in making decisions about information, cognitive styles become a valid approach to analyzing and predicting types of INFOBEHAV 112 and OUTCOME 113.

The internet serves as an interesting setting in terms of drawing out the ‘doing’ side of the personality, since it is an active medium where people control how the medium is used. Information processing in any medium also depends on the motivation and ability of the person.

Some Cognitive Styles Believe to be Important in Predicting Online Behavior

Need for Cognition (NFC)

NFC describes a person's tendency to engage in and enjoy effortful thinking. It is a need to structure relevant situations in meaningful, integrated ways. If this need is unmet, it can actually result in the person feeling of tension or deprivation (dissonance), which leads to active efforts to structure the situation and increase understanding. (see Cohen, A, Stotland, E. Wolfe, D. (1955) “An experimental investigation of need for cognition” Journal of Abnormal and Social Psychologu, 51, 291-294). High NFC's are more likely to organize, elaborate on, and evaluate presented information. There are significant correlations between NFC and INFOBEHAV, and NFC and tendency to react positively or negatively to various forms of online advertising—the way the are presented, and the wording used.

Field Dependent/Independent

This has application to how people interact with information (see Weller, H. G., Repman, J., & Rooze, G. E. (1994). The relationship of learning, behavior, and cognitive styles in hypermedia-based instruction: Implications for design of HBI. Computers in the Schools, 10, 401-420). This is because it reflects how a person restructures information to make sense of it and interpret it, based on the use of cues and field arrangement.

Field Dependence describes the degree to which a learner's perception or comprehension of information is affected by the surrounding perceptual or contextual field. Field-Independent individuals tend to sample more cues in the field, and are able to extract the relevant cues necessary for the completion of a task. In contrast, Field-Dependent individuals take a passive approach, are less discriminating, and attend to the most salient cues regardless of their relevance.

Holists (Global) Versus Serialists (Analysts)

Wholist-analytical: This dimension describes how people process information. Analysts tend to process information into component parts, while wholists prefer to keep a global view of the topic. Serialism is the step by step acquisition of material, while wholism is an exploratory approach where information is first understood as a ‘big picture’ or overview and then broken down into smaller chunks.

Verbaliser-Imager:

This dimension describes how people represent information during recall. Verbalizers prefer to have information presented as words or verbal associations. This type of learner can easily create mental images of the material being presented, therefore they are comfortable with heavy text or verbal presentations. Imagers see things in the form of pictures and prefer material to be presented in vivid context.

Field Dependency and Personality

The field dependence/independence construct is also associated with certain personality characteristics. Field dependent people are considered to have a more social orientation than field independent persons since they are more likely to make use of externally developed social frameworks. They tend to seek out external referents for processing and structuring their information, are better at learning material with human content, are more readily influenced by the opinions of others, and are affected by the approval or disapproval of authority figures. Field independent people, on the other hand, are more capable of developing their own internal referents and are more capable of restructuring their knowledge, they do not require an imposed external structure to process their experiences. Field independent people tend to exhibit more individualistic behaviors since they are not in need of external referents to aide in the processing of information, are better at learning impersonal abstract material, are not easily influenced by others, and are not overly affected by the approval or disapproval of superiors.

A related concept is Locus of Control, where field dependence is the cognitive style, and LOC approximates personality style.

Locus of Control (LOC)

The overall emphasis is on internal versus external control. Internals shape their reality from within, and like to drive their own choices. They are bold in a new medium. The interactivity of the internet and internal LOC's are made for each other. The preferred embodiment assumes that LOC is a fundamental orientation to life, and one which is particularly useful in the online space, because it reflects how a person relates to the outside world as well as internal personality dimension; and it reflects the degree of control they believe the wield over their daily function. Locus of control (LOC) is a generalized expectancy about the degree to which people control their outcomes. At one end of the continuum are those who believe their actions and abilities determine their successes or failures (Internals); whereas, those who believe fate is the main determinant luck, chance, or powerful others determine their outcomes are at the opposite end (Externals).

In general, an Internal LOC orientation is associated with purposive decision making, confidence to succeed at valued tasks, and the likelihood of actively pursuing risky and innovative tasks to reach a goal (see Lefcourt, H. M. (1982). Locus of control: Current trends in theory and research. Hillsdale, N.J.: Lawrence Erlbaum). Externals, on the other hand, are generally less likely to plan ahead and to be well informed in the area of personal financial management tasks and more likely to avoid difficult situations and exhibit avoidant behaviors such as procrastination, withdrawal.

LOC has a predictive ability in INFOBEHAV and OUTCOME. Internal Locus of control's, for example, as far more likely to transact inline, because they prefer to drive the process of information finding and purchase, rather than have a salesperson tell them what to but. Internals react very negatively to pop-up advertisments.

Investigating personality provides insight into consumer traits and behaviors when attempting to predict online behavior. Since increased personal control over outcomes has been cited as one of the major differences consumers experience in a computer mediated environment, use of the LOC construct seems especially relevant when analyzing online behaviors.

An Example of Traits and Styles in Online Behavior

Noting that personality and cognitive style variables are valid predictors of online behavior, traits provide some indication of predisposition to act a certain way online. Cognitive styles like NFC provide more measurable behavioral differences than traits, and they are also more consistent across situation. For example, a personality trait like mistrust may manifest by a person not giving credit card details online, yet that same person may be quite happy to hand their credit card to a waiter at a busy restaurant. Cognitive styles, however, are a more consistent predictor of behavior across information navigation situations.

Grouping the traits and cognitive styles into our INFTYPE typologies provides a means to create rapid measurement of behavior and make accurate predictions of preferred outcome for the user.

Usage Example

To give a somewhat stereotyped example of how these differences allow online prediction & personalization, compare a sales clerk at a fashion store with a senior research analyst at the patent office, and picture them sitting in front of a computer, on the internet. Both are both females under 30. The researcher has recently purchased an apartment in an exclusive area, and the clerk still lives with her parents in the same area, so they share the same zip code. They share demographic similarities, but differ markedly in how they act online, and what sort of information and advertising they would prefer to see.

Personality Traits

Openess to experience/intellectual openness: The clerk may not be intellectually adventurous, and would follow peers. The analyst, in contrast, would be intrigued by new experience, and innovative.

Conscientiousness: the researcher would be more conscientious, in the sense of diligently applying herself to a task until it is accomplished or resolved in some way.

Agreeableness/competitiveness: The clerk is more likely to be affable and gregarious, the analyst competitive and individualistic.

Neuroticism: Assume the clerk is less emotionally stable, and more highly strung.

Locus of control: The analyst is more likely to be internal (drives from within), the clerk external (refers to the outside world).

Cognitive Styles:

Need for cognition (effortful thinking): The clerk can be more likely to not like to tax her brain too much, and make more superficial information decisions. The analyst would have more joy in engaging in thinking—and would be high NFC.

Analytic versus global processing style: The clerk is more likely to be analytic (in the sense of looking at all the little pieces one by one in sequence when approaching a problem) with the analyst more global (able to grasp the bigger picture, and starts by working out the relationship between the concepts before moving onto detailed processing).

How they Behave when they Search—Example

Now think of the two stereotyped women sitting in front of a computer. The store clerk has a fluffy picture frame stuck on her monitor. The analyst has a powerful laptop with wireless high speed Internet. They may be likely to manifest different behavior online.

The analyst will user longer search phrases, spell correctly more often, and would be more likely to use Boolean operators. The analyst would make rapid choices, and have strong and rapid aversion reactions if she sees something she does not like. A global style would mean she would come back to the search page and not get diverted. She would engage in goal directed activity. The analyst would drill down very deeply, into information that is deep on an information taxonomy. She is persistent in her search, and restructures her search phrase repeatedly until she gets the desired results. She is more likely to go past page 2. On a publisher site, she will favour certain types of news content, and she has strong tendencies to favour certain categories of information, in the context of catagorising all the information on the internet. The clerk, in contrast, would use more generic phrases, and is more likely to navigate by clicking on the general sites in succession, rather than drilling down rapidly.

Consider the content itself—and assume that themes within the content can be represented in a rough hierarchy (e.g. from broad to specific->international->accommodation->luxury))—the analyst would drill down a hierarchy much more rapidly, whereas the clerk would browse around at broader and more superficial sites.

The analyst is more likely to spend most of her time online seeking information, and will very often transact online (e.g. banking, research & purchase travel, buy retails and electronic goods and software). The clerk is more likely to use the internet for entertainment-type surfing, and social exchange.

When researching a consumer item online, for example a digital camera, the analyst would respond better to sponsored content that comes as a result of her own goal-directed behavior, and which gives her deep and credible product information and comparative data, and has intelligent text. The clerk may be more likely to respond to graphics and superficial cues, for example a pop-up competition in which she can win a camera, or a picture of really cool people using a certain camera, as she is more likely to make choices based on peripheral cues rather than a decision heuristic.

The analyst would prefer a clean, crisp front end (information interface) that she controls, the clerk is happy to be lead, and wants to be entertained. Being innovative, the analyst would have been online for longer.

Every single one of the factor above are factors the preferred embodiment can respond to algorithmically to personalize results and make predictions as to preferred content, advertising and look & feel.

Consumer and Lifestyle Choices

The women from our example would also be differ in consumers and lifestyle choices:

Travel: The analyst would travel more on business, not want to waste time exploring the choices, and is more likely to travel luxury or adventurous travel (innovative). The clerk may be more interested in organized group tours, or inexpensive packages directed and assembled by someone else.

Career: this is the area where this sort of predictive psychographic work had had the most application and tangible use of research up till now. The clerk is more likely to be interesting in low-thinking administrative or sales positions, the analyst in challenging work.

Financial services: The clerk may be a mild consumer of financial services, with perhaps one or two bank accounts, and a small car loan. The analyst would have a mortgage, own stock and regularly check her stock prices online, and probably would have paid off her first car many years before and be on her second or this new car. She would be more focused on asset growth than frivolous expenditure. They would have different needs when choosing a credit card. In addition, highly conscientious people are more positive about bank services regardless of the actual quality, and are far more likely to have stable income.

Education: The analyst would probably be a lifelong consumer of higher education, the clerk wmay ould be more interested in short skills based courses.

Consumer electronics: They would use different cell phones, computers, and uptake of software. The personality trait of innovativeness has been strongly correlated to tenure (how long someone has been online), how readily they take up new technology, and how readily they transact on the internet.

The INFOTYPE Typologies and Predictive Validity

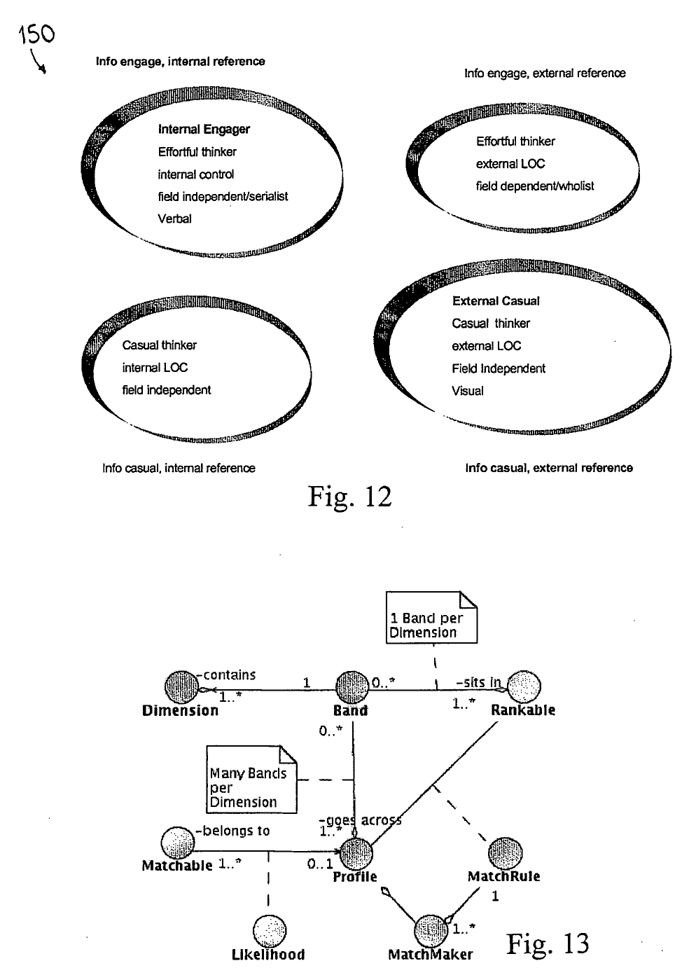

FIG. 12 illustrates a matrix of derived INFOTYPES categories derived from the forgoing analysis which has been found suitable for use in online news sites, and travel advertising.

A number of overlapping matrixes can be developed, depending on situation. They involve the groups of traits which are most important in that situation, the groups of behaviors showing the highest predictive validity, and the type of content applicable in that situation.

An example of how the INFOBEHAV variables are utilised to respond to algorithmically will now be discussed, and OUTCOME variables produced algorithmically, using the example of the internal engaged INFOTYPE typology, and their behavior searching a news site, and response to financial or travel advertisments or new content.

INFOBEHAV 112, Using the Internal Engaged Example

The following activities 115 better categorise the internally engaged individual.

Preferred activity: More information searching. Information deep not superficial. Research, problem solving, less surfing for fun. Entertainment and social surfing, when conducted, is more goal directed. e-commerce—strong tendency to transact online, often based on prior information search. Interested in product information, current news, and learning and education.

Content choices & Info Taxonomy: Deeper faster—deeper levels of an information taxonomy. (eg ‘adventure travel or luxury travel, versus general travel), Significant movement between levels. Choose more ‘goal directed; information & advertising. Choose specific information sites over broad ones. Able to process complex verbal information.

Search phrase style: Longer phrases, less than three words is rare. 5 words 40% of the time and more. More likely to spell correctly. Use words deeper in an information taxonomy. More advanced vocabulary. Uses Boolean operators more than the norm of the time.

Navigation pattern: Shorter time reading landing page before go ahead and interact with the site or leave the site. Strong aversion reactions. Don't go back to a site once dismissed, unless they like it and are engaging in new transaction.

Use of search engine: Use a search engine actively as navigation tool (eg come back, rephrase). Skip around results more, ie don't click result 1 if it doesn't suit them. Persistent—don't give up as quickly. More likely to go to page 2 of engine if not satisfied with page 1. Will do two or more searches on same topic if not satisfied with first, ie use one word from original search phrase and change the rest of the phrase slightly. Time reading landing page—quicker. Less likely to go back to a site they are unhappy with.

Use of search as navigation tool: Search pattern: less likely to click on the first site they see in the search results, more likely to click on the first three one after the other, and declare they are satisfied, or pursue links.

Interactivity: High level of interactivity, IF it is voluntary. React negatively to involuntary approaches e.g. banners, unless highly meaningful. Like control and interaction, but don't like spending too much time customizing things and filling in detailed questions, unless they are convinced of the value of the improvement. Examples of high level of interactivity are 1) clicking into deeper sites searching for more information, 2) providing feedback to advertisers, and 3) saving the contents (i.e., bookmarking) for future reference 3) purchasing or subscribing online. Tendency to search: Will search frequently every day, eg 4× daily or more. Search session will be relatively short.

Technology Medium: More likely to be users of high speed internet, and have wireless and multiple-device access to the internet. Online tenure—longer online. More likely to be linux users.

OUTCOME 113, 116: SPONSORED Content (CONVERSION)

The elaboration likelihood model (ELM). The central and peripheral routes are poles on a processing continuum that shows the degree of mental effort a person exert when evaluating a message. Central route: the extent to which a person thinks about issue-relevant arguments in a persuasive message. Peripheral route processes the message without any active thinking about the attributes of the issue.

An internal engaged user, is much more likely to respond positively to a central processing route to persuasion rather than peripheral cues. The internal engaged user is more likely to feel negative about an unrelated persuasion attempt like a popup advert, and far more likely to be motivated to respond positively to a message related to current interest.

The internal engaged infotype is detected by a combination of the factors listed in the previous section (eg the nature of the content, information deep on a taxonomy, category of information—news story not a horoscope) or behavior like length of search phrase or other such variable. The technology then reconstructs its query to an adserver or advertising database. The advertisments are scored using the same criteria by which behavior and content is scored, and the correct version of the advert is selected for display. For example, if the internal engaged user lands on a particular piece of information on a news site. Without having to track the user, the invention pre-scores the content, then selects an advert using a central route and similar information characteristics to the content.

Or the user goes to a search engine, types a longer search phrase, with more complex language, and more goal directed when represented on a category of information, and the preferred embodiment algorithmically selects the correct version of wording for the of sponsored search listing relevant to the search phrase.

Behavior in e-commerce: Use e-commerce more in retail purchases than norm, both to research and actively transact. Goal directed activity: price comparison, product info, financial info. Regular online financial services and booking. Willing to use technology-mediated learning and job seeking.

Perceived interactivity: Prefers interaction, to control the process (eg more likely to respond to search pay-per-click than a banner ad), particularly if they perceive they are driving it, and system responsiveness is subtle. For success in persuasion, arguments need to involve deep processing, and focus on the quality of the message. Like to see comparative data and product details. Respond better to messages allowing evaluation of product attributes rather than simple peripheral cues eg social influence (‘really cool people like Keanu Reeves use this product”). Relevancy Between Vehicle and Ad—more likely to respond positively to advertising directly related to the information they are already looking at. Respond more positively when the content of the ads matches the content they have selected. For example, if an internal engaged is reading a news site story about stock prices, they are more likely to respond to an advert promising information about the stock market, than a peripheral advert blinking at them about an unrelated financial product.

OUTCOME: LOOK AND FEEL 116

The internal engager can comprehend larger volume of info, but must be succinct. Language can be complex but brief. The information taxonomy should be deeper versus superficial. The attitudes of high internal engagers are based more on an evaluation of product attributes than were the attitudes of low scorers. The attitudes of low high internal engagers are based more on simple peripheral cues inherent in the ads than were the attitudes of high. scorers are not characterized as unable to differentiate cogent from specious arguments, but rather they typically prefer to avoid the effortful, cognitive work required to derive their attitudes based on the merits of arguments presented. They lack the motivation or the ability to scrutinize message arguments carefully, and use some heuristic or cue (e.g., the sheer number of arguments presented) as the primary basis of their judgments.

Low internal engagers scorers are unable to process advertising information, they cannot start active message-related cognitive processing. In this situation (high involvement but no ability to process), as is true in the traditional ELM, people will turn their attention to peripheral aspects of advertising messages such as an attractive source, music, humor, visuals, etc. Contrariwise, when people have the ability to process, they start active and conscious cognitive processing or message-related cognitive thinking.

There are two determining factors in this cognitive processing: 1) the initial attitude and 2) the argument quality of advertising messages. These two factors interact with each other so that they yield three different outcomes: 1) “favorable thoughts predominate,” 2) “unfavorable thoughts predominate,” and 3) “neither or neutral thoughts predominate.” In the case of the last outcome (neutral thoughts), people change to the peripheral route to persuasion by focusing on peripheral cues. If they like peripheral cues, they will temporarily shift their attitude; otherwise, they will retain their initial attitude, 2) an enduring negative attitude change (boomerang) for those who have predominant unfavorable thoughts.

Visual vs textual Look & feel: High internal engagers are more able to handle textual data. The descriptive text should be succinct, related to interests, not simple language. Landing page: should include comparative data, high quality of argument. Credibility vital, but not patronizing. Action invited not pushed. If visuals present, can include product or abstracts.

Internal engagers: Interactivity and advertisers: Prefer to drive the process, not afraid of choices. Don't stop in a site if confronted with choice in direction. More likely to respond to ad delivery driven by their own interaction (eg search PPC), than push (eg banner). Overload capacity: higher tolerance, more persistence. Strong aversion: to patronizing, superficial ads, or attempts at humor that are not subtle enough. Perceived time constraint: perceive that the internet saves time.

CONVERSION: Behavior by Sectors:

Consumer retail: Marked differences in preferred online retail categories. Eg entertainment guides (goal directed) preferred to entertainment celebrity news.

Financial services: Good jobs, manage finances well. Mortgages. Research, eg stock market Trading. Banking: Research, Apply and transact heavily. Online earlier than norm.

News: Significant differences in areas of news they are likely to look at.

What internal engagers react negatively to: Information imposed on them (not voluntary). Non-cerebral information, eg celebrity news, offers to buy things they perceive to be trivial. Front pages cluttered with popularist garbage (eg Yahoo). Pop ups, banners, social networking services. Patronizing tone (we'll take care of the thinking for you), weak arguments, unintelligent humour, earn easy lazy money, grow your gonads, take our quiz. Anything with too many exclamation marks.

Example Scenario One: Travel

An example of how the algorithms select advertisments for display to an internal engager.

Classification

The four prominent dimensions determined as interesting are: Topic Generality—how specific the content is in a classification of human knowledge. Goal-Dependence—whether the purpose of the content is goal-directed or not. Language Complexity—the style of the content. Intention—whether the site is oriented towards shopping, information, or general surfing. The criteria have to be applied not only to content—both static and dynamic, but also to other triggers in the users' view, such as keywords in a search.

We have to measure and assess the content before it gets used. Thus the dependence on an index, in the case of search, and full access to both content and ad databases in the case of published content. In general, some content will hold distinguishing features that allow for allocation in at least one of the proposed dimensions towards an extreme point.

Topic Generality:

To assess whether a piece of content is more or less general, one way to proceed is to develop a list of categories along the lines of DMOZ, Yahoo, or the like. These categories start at a ‘high level’, speaking in general terms, and get to more specific terms ‘deeper’ into the hierarchy. By removing the hierarchy and thinking in terms of approximate levels (grades of specificity), an assessment can be made of content as being quite high, or quite low in its topic broad, or deep. Content can be analysed by clustering the content with categorisation assistance (with minimal weightings on category level), with an assessment of how many categories of each level are represented. This gives an overall ranking (specificity). This needs the content to be sufficiently large to accommodate either clustering en masse, or else category extraction through simple inclusion. Topic identification of keywords can be by matching.

Goal Dependence

It may be possible to identify key phrases that indicate the state of content.

Intention, or Purpose Categorisation

The alternative assessment methodology might allow for a more generalised approach to tagging content. For example, the use of keywords ‘buy’, ‘sale’, etc, are obviously shopping related. There is some overlap here with complexity of language or specificity of topic, as the differentiation between information and surfing, although somewhat subjective, is more likely to relate to the intention of the user, or the market of the content.

Language Complexity

Not only language, but site content complexity comes into play. The simplest test on content can be the number of pictures versus words. A more difficult and intense test is to assess the text for its target education level. This latter can be done with tuned algorithms or through simpler techniques such as analysing the average number of syllables in the words, for example. This last would be as applicable to keyphrases or advert snippets, where the content is not sufficient to assess language-oriented complexity, having almost no structure. Word, or usage complexity comes into play.

Specific to keyphrase analysis is the use of boolean operators and the like, as specific elements that define technical complexity. Here, also, the length of search phrase might lead to realistic identification of the point on the spectrum the user comes from.

Practical Application of Dimensions

To achieve a simplistic singular rating for a user, it is sufficient to identify key traits are contributors to this, and have an accumulative function to summarise varied scores across related dimensions that are considered non-orthogonal. That is, taking into consideration many measurable traits, create a resultant score that indicates something useful represented by or related to the previous discussion, and use that is the key differentiator of both search results and keywords. The applicability of some algorithms to keywords and search results may vary, which can be reflected in weightings, for example, and the accumulation algorithm(s). The final raw scoring can be done on a 0-1 scale. The resultant score will also be 0-1. This score will indicate high NFC.

Topic Specificity

To measure this, there needs to be a topic. There also needs to be a score associated with each topic. The categories can easily be scored within their hierarchy to indicate how general the topic is, as discussed previously with reference to FIG. 8. It equates chiefly to how far down the hierarchy the matching topic is.

In a simplistic sense, the topic of a document is given by: whether the search result arrived at the user with a category. Whether the result had a category associated with it through matching with similar documents, Whether a document's highest-ranking cluster has a category-like name. Whether the result matches a category by its content.

In the simplest sense, matching entails textual correlation, by first match. This works well for a cluster, which is unlikely to match more than one category, but does not work too well for search results that might, in theory, match any number of categories at various levels in the hierarchy. A more complex mechanism for matching could be employed For matching keywords, the shortness of the phrase indicates that a direct match would be sufficient (like a cluster).

Simplistically, a score of 0 for high level catergory correlation, half for medium, 1 for low may be enough. Ideally, the category of a search result is ascertained before it gets clustered. This could be done in indexing on the server or through intentionally looking up someone other search engine's assignation.

The specific implementation relating to queries (search phrases) breaks the keyphrase into its constituent non-boolean words, and tries to match on each of these. The resultant topic specificity can be the average of the words' specificities.

Result Specificity

A new technique devised was to find out just how general a result set the keyphrase itself generated. There is sufficient research to show that if the number of results returned is very large, then the search term is very general. For example, a simple algorithm may be taking the number of results that Inktomi would have retrieved, the score can be provided as:

```
MAX = 2E9
if (N > MAX)
    0
else
    log(MAX/N)/log(MAX)
```

That is, the lowest score is achieved with results greater that 2000000000, which trails off to a maximum of 1 for 1 document.

Topic Goal Directedness

Having matched your category (above), it is possible to also ascertain the goal dependence. This requires a bit more extra work in assigning scores to each available topic. There should be no difference in the score applied to keywords or search results. The weighting, or usefulness, of same will vary.

For a query, category matching is again performed over the words that make up the phrase. In this case, the resultant goal directedness can be the greatest directness of any of the matches.

Language Complexity

In its rawest sense, the complexity of the document or the search result is easily encapsulated by an index, which can rely on a simple interrogation of the number of sentences, words, and syllables in a piece of text. Ideally, this is performed at indexing stage, but it can still be used on a search result, if necessary.

Keyphrase Complexity

A well-formed English phrase or sentence, looking for those indicators is a better way of identifying the complexity or web maturity of the user. The insertion of boolean operators (AND, OR), brackets, or quotes, tends to indicate that the user knows what they are doing. Using one of these pieces of search language gives a half-score. Using more than one indicates a seasoned user.

Weightings

The relative usefulness of each of the possible algorithms going into an accumulative score can be used to get a meaningful comparison point between the query and the set of search results. Suitable weightings can be (in increasing usefulness):
1. Topic Specificity
2. Text Complexity
3. Results Specificity
4. Goal Directedness
5. Keyphrase Complexity

And for a document, the following:
1. Topic Specificity
2. Text Complexity (and within this, in order of checking, one of)
   Existing score of document (achieved in indexing)
   Category of document (achieved through indexing/meta search)
   Category of most important cluster
   Category associated with document content
3. Goal Directedness
   Paradigm Shift in Queries

The preferred embodiment provides a paradigm shift in the way that information retrieval occurs. Including, at the front end, where we take the query (applying measures on the user, and gathering their profile), in the back end, in both how we retrieve, and how we store the data, and in the front end, again, in how we display the results.

Traditional Retrieval

The main aim of search has been to improve on the only two true measures on information retrieval, which are precision and recall. The scenario is best described as a relationship between the query, the database/index, and the results. We will use the following nomenclature:
N the set of documents represented by the database
Q the query
q the set of documents in the database that satisfy the query
n the set of documents returned through information retrieval

In theory, the larger the N, the larger the q (and also the n), for all possible Q, thus the reasoning for having a large database.

Precision is the relationship between what you get from the retrieval, and what satisfies the query, that is the number of documents in n that are also in q, as a ratio of n.

$$precision = {\sum }_{a ∈ n} ( a ∈ q ) / n$$

Recall is the relationship between what you get and what you would have retrieved under perfect conditions, as a ratio of q:

$$recall = \frac{{\sum }_{a ∈ n} ( a ∈ q )}{q}$$

These are, however, ideal measures. It may be effectively impossible to estimate q. It is also difficult to determine the number of relevant results in the returned result set, it is quite subjective, and there is a matter of exactly how relevant each one is, with diminishing usefulness. In fact, for two users issuing the same Q, there will be different q!

Pages of Results

The reality is that we don't ever return the full set of matches n, we select the best, through a ranking algorithm, and deliver pages of results, which are (ordered) subsets of n. The measures mentioned above have to be modified to reflect this, given that n′ is the current page, which is dependent on a fixed, sometimes configurable, but generally static, page size. Recall is diminished if we measure it with a short-sighted notion that there are 10 results in the page, but there are 1000000 results in the database.

Precision can be highly dependent on the ranking. If the ranking algorithm pushes up a result in the list that would otherwise not be a valid match for the query, then it has a greater impact on a smaller number of results displayed. With a ranking based purely on ‘relevance’, the less relevant tend to be towards the bottom of the list of results retrieved, and might be ignored, especially if only the first 10 are being displayed. If any other measure is applied to the order of results, then the irrelevant ones have just as much chance of appearing on the first page.

Traditional Ranking

Static ranking, as it appears in most of the major search engines, applies some measure of relevance to each document in the database, and then uses this measure to order the results for a given query. Effectively, for a query Q, with related entries q, we are ordering the result set n by some measure across and concerning N. A result's relevance to the query is deemed only a part of its relevance to the user, the other part being the static ranking. Where does that static ranking come from? In Google's case, that static ranking is PageRank, which deals with popularity of pages, through links. In Teoma's case, collaborative networks play a part.

Variations of the Preferred Embodiment

IF P is a personality profile of the user and p is the set of documents in the database related to the user, ranked according to the same measure as P, then rather than trying to improve precision or recall, explicitly, so as to bring n closer to q, we have to ask whether q is sufficient in itself. For a given Q, q can be quite large, which is reflected in a large n, but an individual user doesn't need n. In fact, for a given P, the number of results returned could be a factor in measuring the relevance of the result set. The more results returned, the less relevant they are. Therefore it is desireable to use P to determine n, as much as using Q. The ideal result set is q rated by p. We are no closer to retrieving an ideal q, but we can most certainly rate the whole of N by p, and match this against what we know P. Starting with a non-ideal n, we can winnow out all elements that do not match P (are not in p), and tailor the result set to best suit that profile) ranking, limiting the size, etc). The reality is that the profile, P, reflected in p, has a bearing on user satisfaction, which in turn was always reflected in q, that is, q is a function of p (where p satisfies P).

We now find new ways of measuring precision and recall, which are the following:

$$\begin{matrix}precision = \frac{{\sum }_{a ∈ n} a ∈ q ( p )}{n} \\ Recall = \frac{{\sum }_{a ∈ n} a ∈ q ( p )}{q ( p )}\end{matrix}$$

Before, we couldn't measure q, but we can estimate q(p) much more closely. We can (algorithmically) guarantee that n is a subset of p, therefore n is a subset of q(p), therefore precision must be close to 1. As for recall, we have already removed a large chunk of the database that does not qualify as search results, making all of those left variable-value candidates—they at least match the profile, if not the query. From a profile perspective, recall can attain 1 also. Another interpretation of this is that, for a given profile, the number of documents ‘needed’ is known. All candidates are identifiable, therefore the number retrieved can equal either the number needed, or else all of those available.

For algorithmic guarantees, we need to determine that some components of psycho-profile measurement are hard-thresholded, whilst others are broad-matching, and others again are fully variable, and act accordingly, thus:
Threshold—either a result matches criteria by having a measure at a specific level, or it fails to qualify; this could be dependent on the intensity of the measure
Range—if a measure falls within the same band, or range, as the profile, then it matches
Ordering—results are ordered according to how close to the proposed profile measure they are

The first two of these act as filters, to ensure that precision is optimised, the last is used for ordering of most relevance.

New Measures

Precision becomes a measure of closeness between the desired result (P), and the result set retrieved (n). This is dependent on the ability to satisfy the query (which is reflected in the content of N), rather than the ability to extract from the database (N as a complete source of information). From an information retrieval point of view, it has always been assumed that the database was the extent of knowledge. In a search engine, knowledge is summarised in the database. The larger the database, the more knowledge, the more able to retrieve something for a given query. Query-driven accumulation of summaries/knowledge is our intention long-term, and recall takes on a very different formulation.

Although not explicit, q is a function of N, by definition it is at least a subset. But the real q, that which fully satisfies a user, which can also equate to q(p), is a function of K, the body of all knowledge, which is a superset of W, the body of all knowledge on the web, from which we extract N. There are some personalities for which q is a subset of K, but not of W. These we can't help. For most circumstances, though, it will be the case that some elements of the true q are elements of W not in N. For large real-world search engine databases, N represents less than 10% of W. In some cases, less than 1%.

$$recall = \frac{{\sum }_{a ∈ n} a ∈ q ( p , W )}{q ( p , W )}$$

Given that we can guarantee a satisfaction by p, we have to work on a satisfaction by W. This means that, for a given set of all queries {Q}, we have all query result sets {q(p,N)} which approaches {q(p,W)}. Interestingly, this is still quite measurable. Because we temper our requirements on the basis of psychometrics, we can understand that no single user of the system requires, say, a million responses to the query “travel”. This may sound obvious, but it means that one way to create N is to correlate likely queries with likely profiles, and satisfy them accordingly. This will achieve perfect recall, by definition. It will also be a smaller database than 10% of W.

$$recall = \frac{{\sum }_{P} {\sum }_{Q ∈ P} \frac{q ( N , p )}{q ( W , P )}}{{\sum }_{P , Q} 1}$$

Reference is made directly to the user profile, P (and all queries that might come of it), as well as the measurable profile, p. That is, recall is the average recall across all possible queries, related to profiles (not all profiles have all possible queries). Here, N and p are measurable, W is unknown, but can be estimated, p approaches P (but how close is not easily measured). The functions q(p) and q(N) are attainable by intensive research, but are highly subjective, but q(W) is a big unknown.

Weighting

Recall (and to a lesser extent precision) also has to be a result of the weighting of query satisfaction versus profile matching. We know that all results satisfy the profile, but do they satisfy the query? These questions return us to the equation, where q is not dependent on p, or more to the point, where there are elements of q that are not elements of p. We assumed in the above that a satisfied user is one for whom all results were in line with their profile. For specific profiles, this might not be the case. For a very open nature, the amount of mismatch is more tolerant. This also means that the desired nearness of p to P is variable, dependent on P, or, rather, that P is a range whose size varies. We have the ability to retrieve all of p, but do we ever want to? Recall can be thought of as merely a measure of how closely q approaches q(p), which is also a measure of our profiling ability. Remember that q is still not measurable.

In many respects, the query, Q does not represent the user's desires, only their ability to express them, and fulfilling Q is not sufficient in satisfying the user. This is where p, or q(p), which is highly likely to satisfy, has greater relevance.

There are several factors in satisfying P: How many results is considered sufficient (able to be estimated). The profile points (levels on dimensions measured), and accuracy of measuring them. How close to the ideal profile the results need to be to still match (determined experimentally). The ability to exclude negative results (which can be approximated easily).

Satisfaction

A measure of satisfaction can be given by:

$$dissatisfaction = \frac{\sqrt{{\sum }_{a ∈ q ( p )} {\vert a - P \vert}^{a}}}{‖ q ( p ) ‖ - f ( ‖ \vert q ( p ) \vert - \vert P \vert ‖ )}$$

That is, the satisfaction of a result set is dependent on the statistical average of how close to the ideal each result is, but where the average is not just taken over the size of the set, but takes into consideration some function of how close to the ideal set size we have come. In the case of the result set being exactly that specified for the user profile, then this becomes a standard deviation for error, which is the inverse of what we want to express. Where the number of results deviates from the expected, then this error must increase, therefore the denominator should decrease, meaning that f(x) is strictly positive for x (which is an absolute value above). One such candidate function is f(x)=x, but this is too simplistic, and it should have a slow exponential growth. It is also interesting to note that |a−P| is within some error defined by P, which means that there is an upper bound within the expectation of P.

Advertisement Matching

In addition to the above, which shows how to associate a user's entry (keyphrase) with results, the tenor of the advertising can also be varied according to the same rules, although you would most likely match the advertisements to the results as closely as possible, rather than to the keyphrase. In a system where the DAA is used in combination with score matching, the user's preferences in navigation will be added in to their cumulative analysis—represented by the re-ordering of the results, to better choose advertisments applicable at that point in time.

Optional Multi-Dimensional Profile Matching

The aforegoing assumes a single dimension matching capability. More complex algorithms are possible, such as multi-dimensional scoring, and the accumulation of scores in an appropriate manner. FIG. 13 illustrates a class generalization structure. The generalization can proceed in accordance with the following factors:

Dimension 161 and Band 162

A dimension is an axis of psychographic profile that can be measured. Each dimension is broken up into bands. For some dimensions, the bands will be quite large and fuzzy (male, female, unknown), for others, they will be quite heavily graded. It may be implemented such that a score is associated with each Dimenion, and that score will then belong to a Band.

Rankable 163

A dimension is Rankable is something that can be ranked. It will reside in a Band for each of the applicable Dimensions. How it obtains a banding can be dependent on an overall score, which means that Dimension needs to convert from the score to a Band.

Profile 164 and Matchable 167

A Profile is defined to be a collection of Band memberships. Unlike Rankable, a Profile may belong to multiple Bands for a given Dimension, which allows for a broader matching. It makes more sense for a generic Profile to allow for broad-Band matching than it does for Rankables. A Matchable may belong to any number of Profiles with a given Likelihood. A Matchable represents a user instance. Initially, an unknown user has equal Likelihood of belonging to all Profiles. As more information is aggregated (Scores across Dimensions), we can more closely associate a Profile (greater Likelihood 168).

MatchRule 167 and MatchMaker 168

The association between Profiles and Rankables is a MatchRule, which describes how well the match between the two is through associating Bands in each. Some Rules will be hard, to the point of a must have the same Band for this Dimension, while others will be soft (the likelihood of a match is dependent on the number of Bands that match from this subset). A collection of MatchRules is a MatchMaker, which has the ability to accumulate matching Rankables for a given Profile. A MatchMaker belongs to a Profile, because this system is usually driven from the point of view of the Matchable.

Application of the Preferred Embodiment

The preferred embodiment detects interests of the user, based on the pattern of themes in single or multiple pieces of content or search results selected, without having to receive explicit instructions from the user. It is sensitive to change, skews as the user changes in interest. It is applicable in search results, re-ranking dynamically, ad selection, better match to true interests, and selection of new content to be displayed.

The preferred embodiment enables publishers and advertisers to create custom audience segments for their advertisements based on users' demonstrated REAL behaviors across their sites. As such, it opens up a world of new revenue opportunities. Because ads target relevant users, and not pages, publishers can sell more of their site's inventory at a higher CPM than ever before and advertisers can improve coverage and improve cost-per-acquisition.

The preferred embodiment behavioral targeting solution allows advertisers to direct their ads at consumers based on their behavior across a site. Using either interest-based keywords or rules that they specify, advertisers can reach custom audience segments that directly match their target description. They can also dynamically adjust coverage and relevance, resulting in a perfectly tailored audience to meet their advertising objectives.

It also means an increased ability to optimize marketing spend. Now that publishers and advertisers can reach qualified audiences based on their behaviors, they can market more strategically. With the precision and control that the preferred embodiment provides, publishers and advertisers can deliver relevant communications to consumers throughout their lifecycle—from building awareness to increasing brand loyalty to provoking action. Consumers earlier in the cycle can be served untargeted brand messages, while consumers closer to purchase can receive targeted direct response communications. Publishers and advertisers can then monitor the effectiveness for both types of consumers, making adjustments for optimum campaign performance.

The preferred embodiment automatically sorts the contents of databases into groups according to their appeal to various styles. This is applicable to both content databases (eg content presented by publishers, and indexed websites for internet search). It also serves to create a set of rules to query databases for additional content or advertisements, based on prediction made by INFOBEHAV. Therefore if a person manifests certain behavior, or selects certain content, assumptions can be made about underlying cognitive styles and traits, and that can be used to select which content or advertisements the person is likely to respond to positively.

The preferred embodiment is applicable in index scoring, eliminate results that may be relevant based on keyword or implicit theme interest, but are not relevant to the individual, increase the weighting of results that have the score best aligned to the individual, online advert matching, where there is no relationship between content themes, related themes and advert theme, search—given a keyword, which version of text should be selected for a sponsored listing, content—given piece of content, which version of display advert should be selected, Automatic customization/personalization: i.e., given a psychographic accumulated score, select content type and front-end. The content selected does NOT have to relate specifically to themes chosen, but rather to nature of content in term of its appeal to various psychographic groups.

The preferred embodiment can automatically personalizes advertisements using behavior and can work without behavior tracking. The preferred embodiment dynamically selects the right type of message for the right user at the right point in time. As users navigate the Internet, their interests and behaviors change. The preferred embodiment can alight the advertisments and key messages in a way that will make the user more likely to click or read a message, and importantly more likely to act on it once they get there. This is a powerful advertising medium and also is likely to lead to greater conversion.

Using the preferred embodiment leads to to lower cost-per-acquisition (CPA) for advertisers, and better click-through rates (CTR) for search engines and publishers. In addition to simply changing a key message in an advertisement, the preferred embodiment can also respond by automatic personalizing and customizing the content and home page. An additional benefit is that this can work in situation where there is NO match between the advert and the content. For example, a news publisher may want to put up a banner advert that sends clients to their career classifieds, or an advertiser may want to get a new product in front of a target audience that may not have any relationship to the topics in the content itself.

### Industrial Applicability

The arrangements described are applicable to the computer and data processing industries and particularly to the provision and presentation of meaningful search results over computer networks.

The foregoing describes only some embodiments of the present invention, and modifications and/or changes can be made thereto without departing from the scope and spirit of the invention, the embodiments being illustrative and not restrictive.

1. A method of searching a plurality of electronically accessible records, said method comprising the steps of:
receiving a search query from an originator thereof;
searching said electronically accessible records using said query to identify a set of results at least indicating those ones of said records that incorporate at least one component of said search query;
analysing said records of said set to identify one or more themes underlying content of each of said records;
establishing clusters of said results, each said cluster relating a one of said identified themes with each said result being ascribed to at least one of said clusters; and
presenting the search to the originator by displaying a graphical representation of a limited number of said clusters.

2. A method according to claim 1 wherein said graphical presentation comprises an arrangement of selectable icons within a graphical user interface, each said icon representing a corresponding one of said clusters and being associated with an identifier for the corresponding said theme.

3. A method according to claim 2 wherein said graphical representation comprises a centrally located non-selectable representation of said search query and a limited plurality of said icons surrounding said central representation.

4. A method according to claim 3 wherein each said surrounding icon is associated with a graphically represented link to said central presentation.

5. A method according to claim 4 wherein said graphical presentation comprises a starburst representation.

6. A method for presenting search results associated with a query of a plurality of electronically accessible documents; said method comprising the steps of:
(a) analysing said search results of said set to identify one or more themes underlying content of each of said records;
(b) establishing clusters of said results, each said cluster relating a one of said identified themes with each said result being ascribed to at least one of said clusters;
(c) presenting said search results associated with at least one said cluster to a user in a first ranked order of relevance and detecting a selection of one said presented search result by the user;
(d) modifying the presented ranked order of relevance of at least said one cluster according to attributes of said one selected search result; and
(e) repeating steps (c) and (d) as a consequence of each selection of a further one of said presented search results.

7. A method according to claim 6 wherein step (d) further comprises maintaining a score value associated with each said result and updating said score value for each result in a corresponding cluster from which the presented search result was selected.

8. A method according to claim 7 wherein step (d) further comprises updating the score value for said selected presented search result in each cluster said search result is present.

9. A method according to claim 8 wherein step (d) further comprises updating a score value of each search result in each said cluster in which said selected search result is present.

10. A method according to claim 8 wherein the updating of said score value is weighted in favour of said selected search result compared to other ones of said search results in the corresponding said cluster.

11. A method according to claim 9 wherein:
the updating of said score value is weighted in favour of said selected search result compared to other ones of said search results in the corresponding said cluster; and
said weighted updating is done in favour of said selected search result compared to other ones of said search results across all said clusters.

12. A method according to claim 6 wherein said attribute includes an averaged score value associated with said one search result as spread amongst said clusters.

13. A method for presenting search results associated with a query of a plurality of electronically accessible documents; said method comprising the steps of:
(a) presenting said search results to a user in a first ranked order of relevance related to said query;
(b) detecting a selection of one said presented search result by the user;
(c) determining from the selection of said one search result a relevance measure of said one search result compared to others of said search results
(d) modifying the presented ranked order of relevance of said search results according to said relevance measure; and
(e) repeating steps (c) and (d) as a consequence of each selection of a further one of said presented search results.

14. A method according to claim 13 wherein step (d) further comprises maintaining a score value associated with each said result and updating said score value for each result.

15. A method of searching a plurality of electronically accessible records, said method comprising the steps of:
(a) receiving a search query from an originator thereof;
(b) searching said electronically accessible records using said query to identify a set of results at least indicating those ones of said records that incorporate at least one component of said search query;
(c) analysing said search results of said set to identify one or more themes underlying content of each of said records;
(d) establishing clusters of said results, each said cluster relating a one of said identified themes with each said result being ascribed to at least one of said clusters;
(e) presenting the search to the originator by displaying a graphical representation of a limited number of said clusters;
(f) detecting a selection of one of said clusters and presenting said search results associated with said one cluster to the originator in a first ranked order of relevance;
(g) detecting a selection of one said presented search result by the originator;
(h) modifying the presented ranked order of relevance of at least said one cluster according to attributes of said one selected search result; and
(i) repeating steps (g) and (h) as a consequence of each selection of a further one of said presented search results.

16. A method by which additional content, including, but not restricted to, paid listings, directory entries, and direct content of web pages, is incorporated into a display of clustered search results, based on themes common to the user's selections.

17. A method of searching a plurality of electronically accessible records, said method comprising the steps of:
analysing themes within content returned by a ranked search result;
observing a behavior of a user when examining said search result;
extrapolating information from the observed behavior; and
dynamically ranking the search result according to said information.

18. A method according to claim 18 wherein said analysing comprises clustering said search results and identifying themes within each said cluster, said observing comprises recording a user's access to an individual one of said search results, and said extrapolating comprises dynamically amplifying said user's actions by ascribing a relevance measure to each said search result, and said dynamic ranking comprises re-ranking the search result according to the corresponding relevance measure.

19. A method according to claim 18 further comprising incorporating additional content into a display of said ranked search results, based on themes common to the user's selections.

20. A method according to claim 19 wherein said additional content includes at least one of paid listings, directory entries, and direct content of web pages.

21. A computer readable medium having a computer program recorded thereon, said computer program including code adapted to perform the method of claims 1.

22. A method of improving a user's online information searching capabilities whilst utilizing a computer interface for information searching, the method including the steps of:
(a) providing the user with an interface for information searching;
(b) monitoring a user's utilization of the interface;
(c) classifying the sophistication of the monitored behavior in accordance with a series of criteria;
(d) utilizing said classification to alter the characteristics of information provision to the user of said interface.

23. A method as claimed in claim 22 wherein said interface clusters information of relevance to a search and said alteration comprises altering the relevance of clusters in accordance with the classification.

24. A method as claimed in claim 22 wherein said interface clusters information of relevance to a search and said classification is correlated with the user's interaction with said clusters.

25. A method as claimed in claim 22 wherein said classification is correlated with the perceived sophistication of interrogation of said interface.

26. A method as claimed in claim 22 wherein said classification is correlated with a perceived personality type of said user.

27. A method as claimed in claim 23 wherein said perceived personality type is derived from the user's interaction with the interface.

28. A method as claimed in claim 27 wherein said derivation includes a factor of whether the user's interaction includes Boolean operators.
